(19) United States
(12) Patent Application Publication
(10) Pub. No.: US 2025/0312694 A1
(43) Pub. Date: Oct. 9, 2025

(54) STORAGE MEDIUM, GAME SYSTEM, GAME APPARATUS, AND GAME PROCESSING METHOD

(71) Applicant: NINTENDO CO., LTD., Kyoto (JP)

(72) Inventors: Tsubasa SAKAGUCHI, Kyoto (JP); Yusuke AMANO, Kyoto (JP); Masaki WADA, Kyoto (JP); Shinya YANO, Kyoto (JP); Kenji IWATA, Kyoto (JP)

(21) Appl. No.: 19/170,557

(22) Filed: Apr. 4, 2025

(30) Foreign Application Priority Data
Apr. 8, 2024 (JP) 2024-062194

(51) Int. Cl. A63F 13/42; A63F 13/50

(52) U.S. Cl. CPC A63F 13/42; A63F 13/50

(57) ABSTRACT

A player character is caused to move in a three-dimensional virtual space according to a first operation input. In the three-dimensional virtual space, a first object that connects a reference point set at a position according to a second operation input, and the player character is generated. A shape of the first object is changed based on movement of the player character. When a second object is surrounded by the first object in the three-dimensional virtual space, the second object is designated for further game processing.

### CROSS REFERENCE TO RELATED APPLICATION

This application claims priority to Japanese Patent Application No. 2024-062194, filed on Apr. 8, 2024, the entire contents of which are incorporated herein by reference.

### FIELD

The technology disclosed herein relates to storage media, game systems, game apparatuses, game processing methods, and the like that perform processing using an object in a virtual space.

### BACKGROUND AND SUMMARY

There has conventionally been an information processing system in which an object to be subjected to a predetermined process is set when a player character and a cursor are moved.

However, in the above information processing system, the movements of both the player character and the cursor need to be controlled, and therefore, a complicated operation is required.

With the above in mind, the present example discloses a storage medium, game system, game apparatus, and game processing method that allow easy setting of an object to be processed and the like.

The present example may have features (1) to (13) below, for example.

(1) An example configuration of one or more non-transitory computer-readable storage media storing a program according to the present example are one or more non-transitory computer-readable storage media having stored therein a program that when executed, causes one or more processors of an information processing apparatus to execute information processing comprising: causing a player character to move in a three-dimensional virtual space according to a first operation input; generating, in the three-dimensional virtual space, a first object that connects a reference point set at a position according to a second operation input, and the player character, wherein a shape of the first object is changed based on movement of the player character; and when a second object is surrounded by the first object in the three-dimensional virtual space, designating the second object for further game processing (e.g., which may include a first/predetermined process).

With the configuration of (1), an object can be designated as one to be subjected to the further game processing.

(2) In the configuration of (1), the information processing may further comprise: based on a position of the player character, setting a new reference point at a position different from the reference point; and changing the shape of the first object such that the plurality of reference points and the player character are connected with straight lines.

With the configuration of (2), the designated second object can be easily surrounded using the first object by causing the player character to move.

(3) In the configuration of (2), the information processing may further comprise: changing the shape of the first object such that the first object connects the reference point and a destination position to which the player, according to at least one of turning of the first object around the reference point and a change in a length of the first object to the reference point based on the destination position; and setting a new reference point when the first object, the shape of which has been changed, is brought into contact with the second object.

With the configuration of (3), a length of the first object required to surround the second object can be reduced, resulting in a simpler shape of the first object.

(4) In the configuration of (3), the information processing may further comprise: setting the new reference point at a position away from the second object when the first object is brought into contact with the second object.

With the configuration of (4), an unnecessary contact between the first object and the second object can be avoided, and therefore, an increase in the number of reference points due to the contact can be prevented.

(5) In any one of the configurations of (1) to (4), the information processing may further comprise: executing the further game processing on the designated second object, based on further movement of the player character.

With the configuration of (5), after the second object is designated to be subjected to the further game processing based on movement of the player character, when the movement of the player character is directly continued, the further game processing can be executed.

(6) In the configuration of (5), the further game processing may comprise a process of moving the designated second object in the three-dimensional virtual space, in association with the player character, according to further movement of the player character.

With the configuration of (6), after the second object is designated to be subjected to the further game processing based on movement of the player character, when the player character moves in a direction in which the user desires to carry the second object, the second object can be directly carried.

(7) In any one of the configurations of (1) to (6), the information processing may further comprise: executing the further game processing when a distance between the player character and an intersection position where the first object intersects itself, surrounding the second object, as viewed in a first direction in the three-dimensional virtual space is at least a first distance.

With the configuration of (7), the further game processing may be forbidden, depending on the environment of the game space, and therefore, it is possible to cause the user to decide how to deal with the first object or the like.

(8) In the configuration of (7), the information processing may further comprise: when a section of the first object connecting the reference point and the player character is moved by movement of the player character, then if the intersection position where the first object intersects itself as viewed in the first direction is changed, executing the further game processing using the changed intersection position.

With the configuration of (8), the shape of the second object can be prevented from being complicated.

(9) In the configuration of (7) or (8), the information processing may further comprise: based on a change in a distance between the intersection position and the player character, changing a display form of at least a section of the first object connecting the intersection position and the player character.

With the configuration of (9), a change in the distance between the intersection position and the player character can be easily recognized by the user.

(10) In any one of the configurations of (1) to (9), the information processing may further comprise: when the second object is surrounded by the first object, changing a display form of the first object into a display form that is different from when the second object is not surrounded by the first object.

With the configuration of (10), the user can be notified that the second object is surrounded by the first object.

(11) In any one of the configurations of (1) to (10), the information processing may further comprise: executing the further game processing on the designated second object when the reference point is set at a position based on the second object satisfying a condition according to the second operation input, and the player character moves in a direction away from the second object by at least a second distance.

With the configuration of (11), even when the second object is not surrounded by the first object, the second object can be designated as an object to be subjected to the further game processing.

(12) In the configuration of (1), the information processing may further comprise: setting a new reference point at a position different from the reference point based on a third operation input; and changing the shape of the first object such that the plurality of reference points and the player character are connected with straight lines.

With the configuration of (12), a reference point can be set at a position desired by the user.

(13) In the configuration of (1), the information processing may further comprise: changing the shape of the first object according to a movement path of the player character after the reference point is set in the three-dimensional virtual space.

With the configuration of (13), the first object having a shape based on the movement path of the player character can be caused to appear.

The present example may be carried out in the form of a game system, game apparatus, and game processing method.

According to the present example, an object to be processed can be easily set.

These and other features, aspects and advantages of the subject matter described herein will become more apparent from the following detailed description of the present exemplary embodiment when taken in conjunction with the accompanying drawings.

### BRIEF DESCRIPTION OF THE DRAWINGS

FIG. 1 is a diagram illustrating a non-limiting example of a state in which a left controller 3 and a right controller 4 are attached to a main body apparatus 2,

FIG. 2 is a diagram illustrating a non-limiting example of a state in which a left controller 3 and a right controller 4 are detached from a main body apparatus 2,

FIG. 3 illustrates six orthogonal views of a non-limiting example of a main body apparatus 2,

FIG. 4 illustrates six orthogonal views of a non-limiting example of a left controller 3,

FIG. 5 illustrates six orthogonal views of a non-limiting example of a right controller 4,

FIG. 6 is a block diagram illustrating a non-limiting example of an internal configuration of a main body apparatus 2,

FIG. 7 is a block diagram illustrating non-limiting examples of internal configurations of a main body apparatus 2, a left controller 3, and a right controller 4,

FIG. 8 is a diagram illustrating a non-limiting example of a game image in which a player character PC is displayed in a game space,

FIG. 9 is a diagram illustrating a non-limiting example of a first stage of a player character PC's action of surrounding terrain objects Lt using a selection tool object OBJ so as to subject the terrain objects Lt to a predetermined process,

FIG. 10 is a diagram illustrating a non-limiting example of a second stage of a player character PC's action of surrounding terrain objects Lt using a selection tool object OBJ so as to subject the terrain objects Lt to a predetermined process,

FIG. 11 is a diagram illustrating a non-limiting example of a third stage of a player character PC's action of surrounding terrain objects Lt using a selection tool object OBJ so as to subject the terrain objects Lt to a predetermined process,

FIG. 12 is a diagram illustrating a non-limiting example of a fourth stage of a player character PC's action of surrounding terrain objects Lt using a selection tool object OBJ so as to subject the terrain objects Lt to a predetermined process,

FIG. 13 is a diagram illustrating a non-limiting example of a more detailed change of a shape of a selection tool object OBJ when the selection tool object OBJ surrounds terrain objects Lt,

FIG. 14 is a diagram illustrating a non-limiting example of a more detailed change of a shape of a selection tool object OBJ when the selection tool object OBJ surrounds terrain objects Lt,

FIG. 15 is a diagram illustrating a non-limiting example of an offset position set for terrain objects Lt,

FIG. 16 is a diagram illustrating a non-limiting example of removal of a reference point that has once been set,

FIG. 17 is a diagram illustrating a non-limiting example of movement of a position of an intersection reference point Px that has been set,

FIG. 18 is a diagram illustrating a non-limiting example of setting of a reference point based on a user's operation,

FIG. 19 is a diagram illustrating a non-limiting example of setting of a reference point according to a movement path of a player character PC,

FIG. 20 is a diagram illustrating a non-limiting example of formation of a plurality of loops by a selection tool object OBJ,

FIG. 21 is a diagram illustrating a non-limiting example of a data area set in a DRAM 85 of a main body apparatus 2,

FIG. 22 is a flowchart illustrating a non-limiting example of a game process that is executed in a game system 1,

FIG. 23 is a subroutine illustrating a non-limiting example of a first half of a player character control process in step S123 of FIG. 22,

FIG. 24 is a subroutine illustrating a non-limiting example of a second half of the player character control process in step S123 of FIG. 22, and

FIG. 25 is a subroutine illustrating a non-limiting example of a selection tool updating process in step S149 of FIG. 23.

### DETAILED DESCRIPTION OF NON-LIMITING EXAMPLE EMBODIMENTS

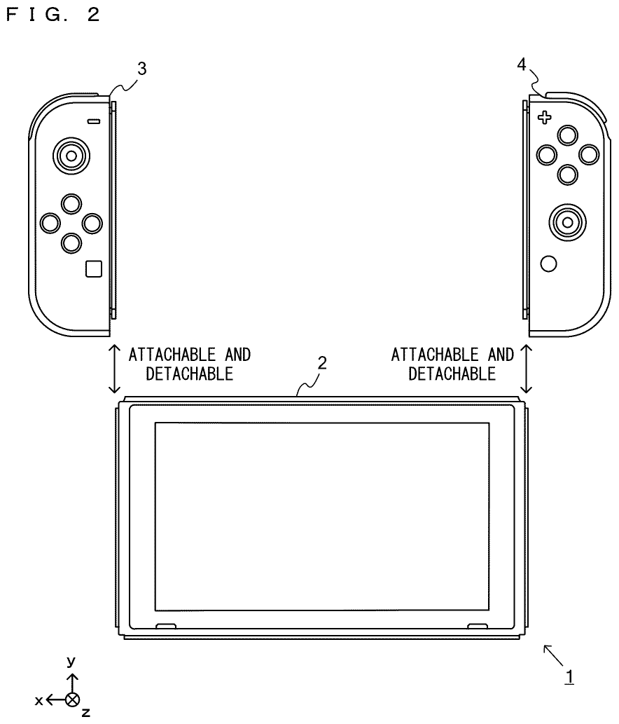

A game system according to the present example will now be described. An example of a game system 1 according to the present example includes a main body apparatus (information processing apparatus serving as the main body of a game apparatus in the present example) 2, a left controller 3, and a right controller 4. The left controller 3 and the right controller 4 are attachable to and detachable from the main body apparatus 2. That is, the user can attach the left controller 3 and the right controller 4 to the main body apparatus 2, and use them as a unified apparatus. The user can also use the main body apparatus 2 and the left controller 3 and the right controller 4 separately from each other (see FIG. 2). In the following description, a hardware configuration of the game system 1 of the present example is described, and thereafter, the control of the game system 1 of the present example is described.

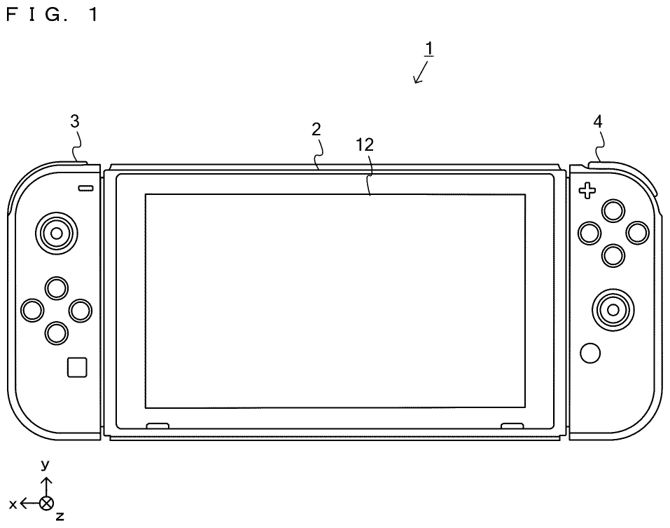

As illustrated in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

As illustrated in FIGS. 1 and 2, the left controller 3 and the right controller 4 are attachable to and detachable from the main body apparatus 2. It should be noted that hereinafter, the left controller 3 and the right controller 4 will occasionally be referred to collectively as a “controller”.

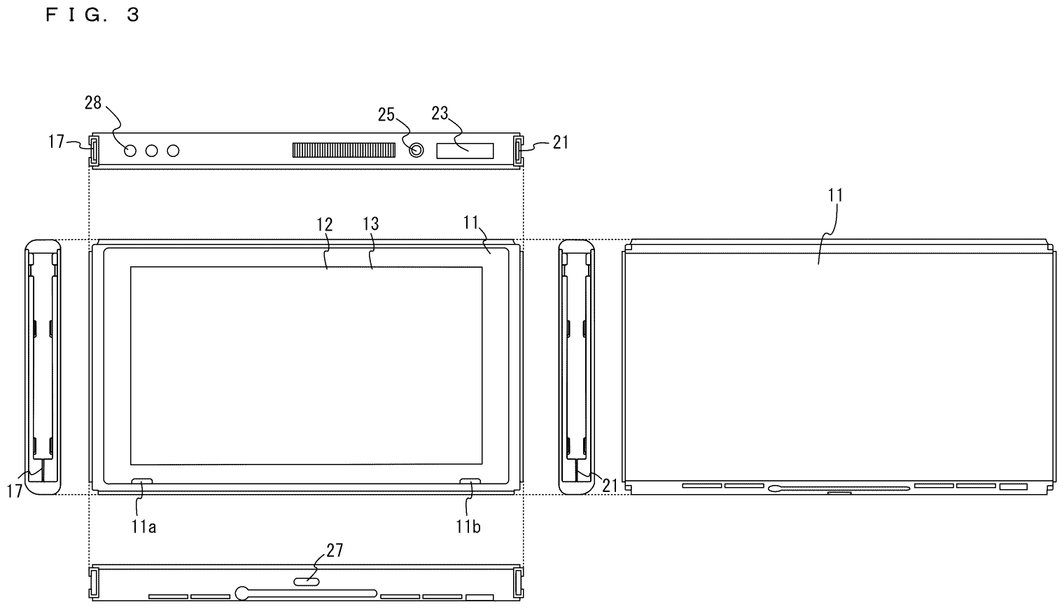

As illustrated in FIG. 3, the main body apparatus 2 includes an approximately plate-shaped housing 11. In the present example, a main surface (e.g., a surface on a front side, such as a surface on which the display 12 is provided) of the housing 11 has a generally rectangular shape.

It should be noted that the shape and the size of the housing 11 are optional. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As illustrated in FIG. 3, the main body apparatus 2 includes the display 12, which is provided on the main surface of the housing 11. The display 12 displays an image generated by the main body apparatus 2. In the present example, the display 12 is a liquid crystal display device (LCD). The display 12, however, may be a display device of any suitable type.

In addition, the main body apparatus 2 includes a touch panel 13 on the screen of the display 12. In the present example, the touch panel 13 allows multi-touch input (e.g., a capacitive touch panel). It should be noted that the touch panel 13 may be of any suitable type, e.g., it allows single-touch input (e.g., a resistive touch panel).

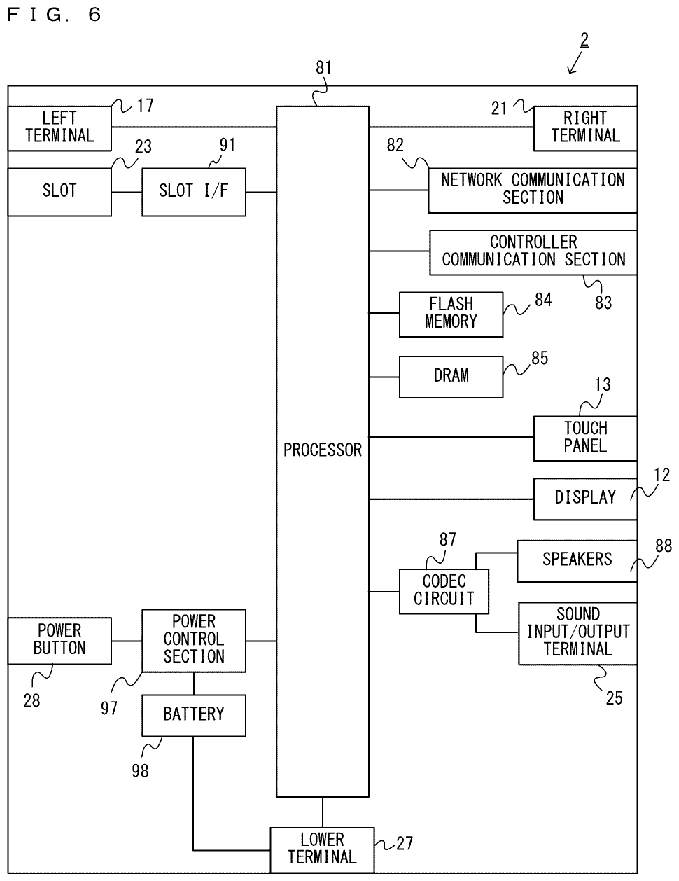

The main body apparatus 2 includes a speaker (e.g., a speaker 88 illustrated in FIG. 6) inside the housing 11. As illustrated in FIG. 3, speaker holes 11a and 11b are formed in the main surface of the housing 11. The speaker 88 outputs sounds through the speaker holes 11a and 11b.

The main body apparatus 2 also includes a left-side terminal 17 that enables wired communication between the main body apparatus 2 and the left controller 3, and a right-side terminal 21 that enables wired communication between the main body apparatus 2 and the right controller 4.

As illustrated in FIG. 3, the main body apparatus 2 includes a slot 23. The slot 23 is provided on an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower-side terminal 27. The lower-side terminal 27 allows the main body apparatus 2 to communicate with a cradle. In the present example, the lower-side terminal 27 is a USB connector (more specifically, a female connector). When the unified apparatus or the main body apparatus 2 alone is placed on the cradle, the game system 1 can display, on a monitor, an image that is generated and output by the main body apparatus 2. The monitor may be stationary or may be movable. Also, in the present example, the cradle has the function of charging the unified apparatus or the main body apparatus 2 alone, being placed thereon. The cradle also functions as a hub device (specifically, a USB hub).

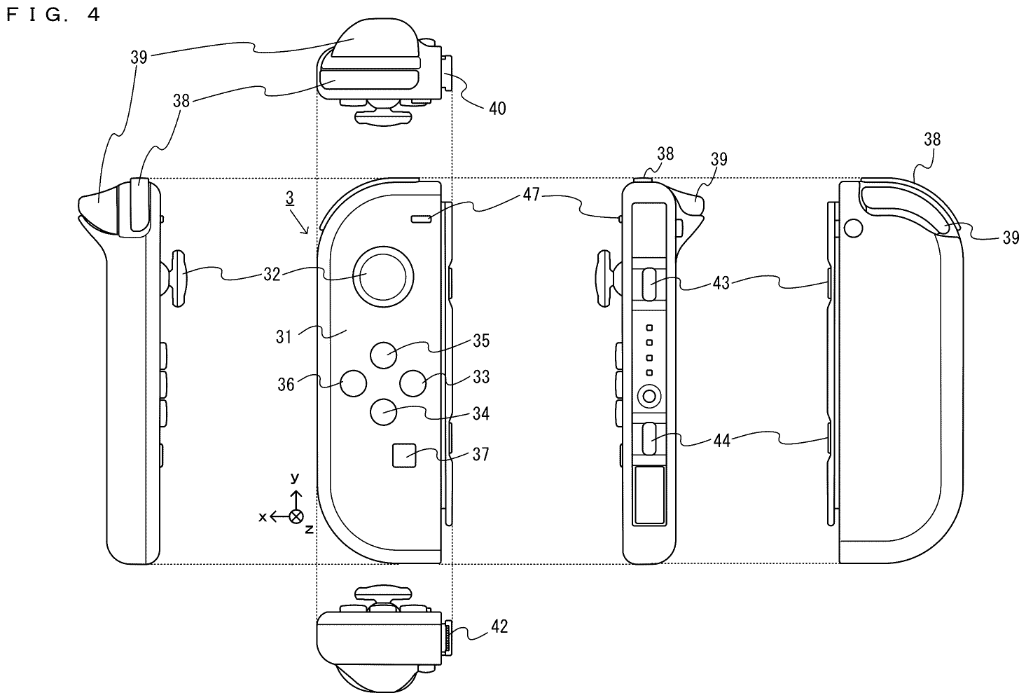

As illustrated in FIG. 4, the left controller 3 includes a housing 31. In the present example, the housing 31 has a vertically long shape. The housing 31 may be shaped to be long in an up-down direction, e.g., along the y-axis direction illustrated in FIGS. 1 and 4. In the state in which the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly the left hand. Further, the left controller 3 can also be held in the orientation in which the left controller 3 is horizontally long. When held in the orientation in which the left controller 3 is horizontally long, the left controller 3 may be held with both hands.

The left controller 3 includes an analog stick 32. As illustrated in FIG. 4, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the present example, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give commands depending on various programs (e.g., an operating system (OS) program and an application program) executed by the main body apparatus 2.

The left controller 3 also includes a terminal 42 that enables wired communication between the left controller 3 and the main body apparatus 2.

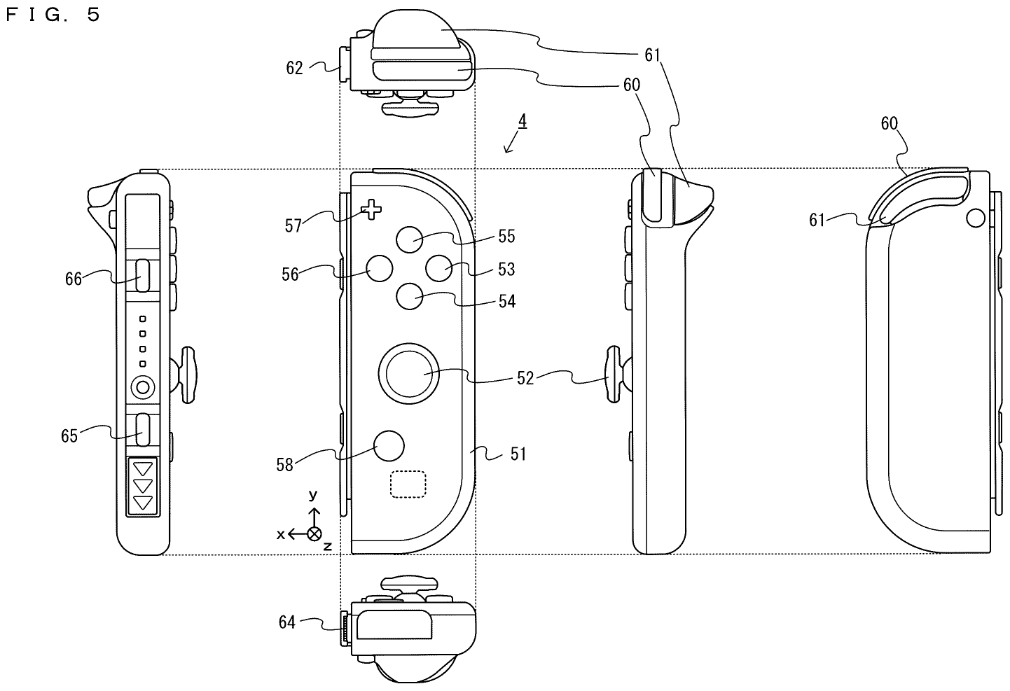

As illustrated in FIG. 5, the right controller 4 includes a housing 51. In the present example, the housing 51 has a vertically long shape. For example, the housing 51 may be shaped to be long in the up-down direction. In the state in which the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes an analog stick 52 as a direction input section. In the present example, the analog stick 52 has the same configuration as that of the analog stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for allowing the right controller 4 to perform wired communication with the main body apparatus 2.

The main body apparatus 2 includes components 81 to 91, 97, and 98 illustrated in FIG. 6 in addition to the components illustrated in FIG. 3. Some of the components 81 to 91, 97, and 98 may be implemented as electronic parts on an electronic circuit board, which is contained in the housing 11.

The main body apparatus 2 includes a processor 81. The processor 81 is an information processor for executing various types of information processing to be executed by the main body apparatus 2. For example, the processor 81 may include only a central processing unit (CPU), or may be a system-on-a-chip (SoC) having a plurality of functions such as a CPU function and a graphics processing unit (GPU) function. The processor 81 executes an information processing program (e.g., a game program) or other instructions that are stored in storage (e.g., an internal non-transitory storage medium such as a flash memory 84, an external non-transitory storage medium that is attached to the slot 23, or the like), thereby executing the various types of information processing.

The main body apparatus 2 includes a flash memory 84 and a dynamic random access memory (DRAM) 85 as examples of internal storage media built in itself. The flash memory 84 and the DRAM 85 are connected to the CPU 81. The flash memory 84 is mainly used to store various data (or programs) to be saved in the main body apparatus 2. The DRAM 85 is used to temporarily store various data used in information processing. The DRAM 85 and the flash memory 84 are illustrative non-limiting examples of non-transitory computer-readable media.

The main body apparatus 2 includes a slot interface (hereinafter abbreviated to “I/F”) 91. The slot I/F 91 is connected to the processor 81. The slot I/F 91 is connected to the slot 23, and reads and writes data from and to a predetermined type of storage medium (e.g., a dedicated memory card) attached to the slot 23, in accordance with commands from the processor 81.

The processor 81 reads and writes, as appropriate, data from and to the flash memory 84, the DRAM 85, and each of the above storage media, thereby executing the above information processing.

The main body apparatus 2 includes a network communication section 82. The network communication section 82 is connected to the processor 81. The network communication section 82 communicates (specifically, through wireless communication) with an external apparatus via a network. In the present example, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined communication method (e.g., communication based on a particular protocol or infrared light communication). It should be noted that the wireless communication in the above second communication form achieves the function of allowing so-called “local communication”, in which the main body apparatus 2 can wirelessly communicate with another main body apparatus 2 located in a closed local network area, and the plurality of main body apparatuses 2 directly communicate with each other to social data.

The main body apparatus 2 includes a controller communication section 83. The controller communication section 83 is connected to the processor 81. The controller communication section 83 wirelessly communicates with the left controller 3 and/or the right controller 4. The main body apparatus 2 may communicate with the left and right controllers 3 and 4 using any suitable communication method. In the present example, the controller communication section 83 performs communication with the left and right controllers 3 and 4 in accordance with the Bluetooth (registered trademark) standard.

The processor 81 is connected to the left-side terminal 17, the right-side terminal 21, and the lower-side terminal 27. When performing wired communication with the left controller 3, the processor 81 transmits data to the left controller 3 via the left-side terminal 17 and also receives operation data from the left controller 3 via the left-side terminal 17. Further, when performing wired communication with the right controller 4, the processor 81 transmits data to the right controller 4 via the right-side terminal 21 and also receives operation data from the right controller 4 via the right-side terminal 21. Further, when communicating with the cradle, the processor 81 transmits data to the cradle via the lower-side terminal 27. As described above, in the present example, the main body apparatus 2 can perform both wired communication and wireless communication with each of the left and right controllers 3 and 4. Further, when the unified apparatus obtained by attaching the left and right controllers 3 and 4 to the main body apparatus 2 or the main body apparatus 2 alone is attached to the cradle, the main body apparatus 2 can output data (e.g., image data or sound data) to a stationary monitor or the like via the cradle.

Here, the main body apparatus 2 can communicate with a plurality of left controllers 3 simultaneously (or in parallel). Further, the main body apparatus 2 can communicate with a plurality of right controllers 4 simultaneously (or in parallel). Thus, a plurality of users can simultaneously provide inputs to the main body apparatus 2, each using a set of left and right controllers 3 and 4. As an example, a first user can provide an input to the main body apparatus 2 using a first set of left and right controllers 3 and 4, and at the same time, a second user can provide an input to the main body apparatus 2 using a second set of left and right controllers 3 and 4.

Further, the display 12 is connected to the processor 81. The processor 81 displays, on the display 12, a generated image (e.g., an image generated by executing the above information processing) and/or an externally obtained image.

The main body apparatus 2 includes a codec circuit 87 and speakers (specifically, a left speaker and a right speaker) 88. The codec circuit 87 is connected to the speakers 88 and an audio input/output terminal 25 and also connected to the processor 81. The codec circuit 87 is for controlling the input and output of audio data to and from the speakers 88 and the sound input/output terminal 25.

The main body apparatus 2 includes a power control section 97 and a battery 98. The power control section 97 is connected to the battery 98 and the processor 81. Further, although not illustrated, the power control section 97 is connected to components of the main body apparatus 2 (specifically, components that receive power supplied from the battery 98, the left-side terminal 17, and the right-side terminal 21). Based on a command from the processor 81, the power control section 97 controls the supply of power from the battery 98 to each of the above components.

Further, the battery 98 is connected to the lower-side terminal 27. When an external charging device (e.g., the cradle) is connected to the lower-side terminal 27, and power is supplied to the main body apparatus 2 via the lower-side terminal 27, the battery 98 is charged with the supplied power.

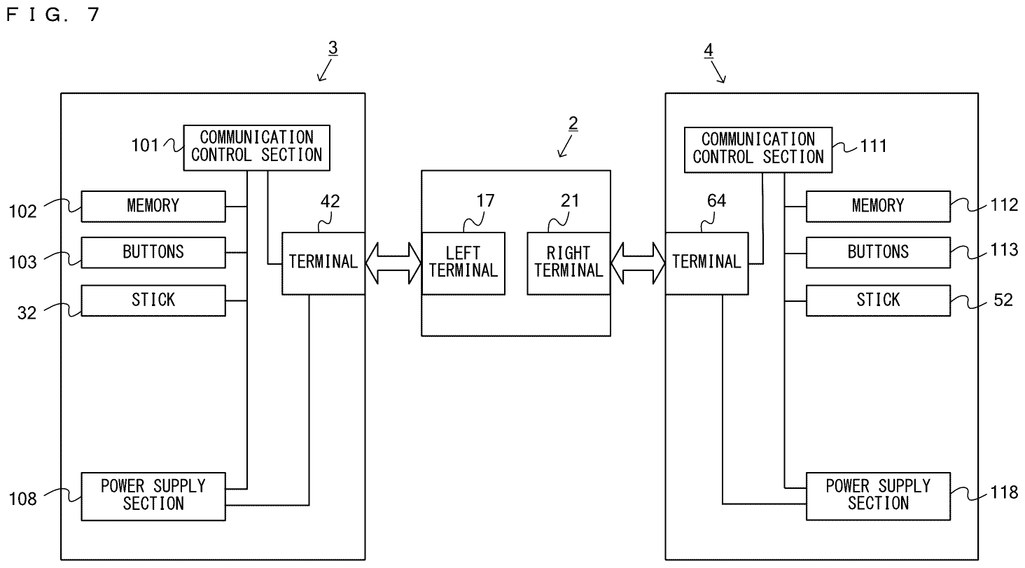

The left controller 3 includes a communication control section 101, which communicates with the main body apparatus 2. As illustrated in FIG. 7, the communication control section 101 is connected to components including the terminal 42. In the present example, the communication control section 101 can communicate with the main body apparatus 2 through both wired communication via the terminal 42 and wireless communication without via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the analog stick (“stick” in FIG. 7) 32. Each of the buttons 103 and the analog stick 32 outputs information regarding an operation performed on itself to the communication control section 101 repeatedly at appropriate timing.

The communication control section 101 obtains information regarding an input (specifically, information regarding an operation or the detection result of the sensor) from each of input sections (specifically, the buttons 103 and the analog stick 32). The communication control section 101 transmits operation data including the obtained information (or information obtained by performing predetermined processing on the obtained information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 32 based on the operation data.

The left controller 3 includes a power supply section 108. In the present example, the power supply section 108 includes a battery and a power control circuit. Although not illustrated in FIG. 7, the power control circuit is connected to the battery and also connected to components of the left controller 3 (specifically, components that receive power supplied from the battery).

As illustrated in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, a communication control section 111 can communicate with the main body apparatus 2 through both wired communication via the terminal 64 and wireless communication without via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113, and the analog stick 52. These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

As described above, in the game system 1 of the present example, the left controller 3 and the right controller 4 are removable from the main body apparatus 2. In addition, when the unified apparatus obtained by attaching the left controller 3 and the right controller 4 to the main body apparatus 2 or the main body apparatus 2 alone is attached to the cradle, an image (and sound) can be output on an external display device, such as a stationary monitor or the like. The game system 1 will be described below according to an embodiment in which an image is displayed on the display 12. It should be noted that in the case in which the game system 1 is used in an embodiment in which an image is displayed on the display 12, the game system 1 may be used with the left controller 3 and the right controller 4 attached to the main body apparatus 2 (e.g., the main body apparatus 2, the left controller 3, and the right controller 4 are integrated in a single housing).

A game is played using a game space displayed on the display 12, according to operations performed on the operation buttons and sticks of the left controller 3 and/or the right controller 4, or touch operations performed on the touch panel 13 of the main body apparatus 2, in the game system 1. In the present example, as an example, a game can be played using a player character PC that performs actions in the game space according to the user's operation performed using the operation buttons and sticks.

In the present example, in the information processing system, a plurality of game systems 1 may exchange operation information through a server or the like, so that a networked game in which player characters corresponding to respective users perform actions in the same game space as a shared space may be played. The operation information exchanged in the networked game may be information about player characters operated by the users using controllers, information about a game space edited by the player characters' actions, details of operations themselves performed by the users operating the player characters using controllers, or other information with which game progression in the game systems I can be understood.

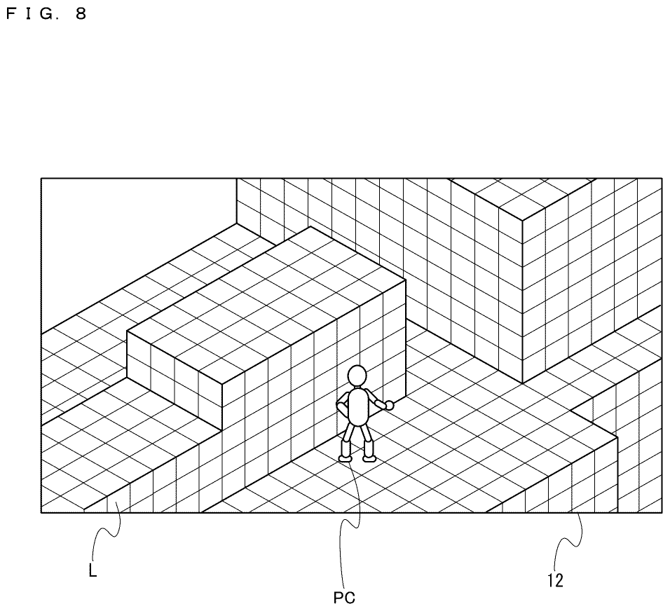

An example game process that is executed in the game system 1 will be outlined with reference to FIGS. 8 to 19. Firstly, in the overview of the example game process, a game space that is used in the example game process will be outlined with reference to FIG. 8.

In FIG. 8, in the present example, a game field is constituted by a plurality of unit regions. For example, the unit regions are obtained by dividing the game field into squares arranged in a grid pattern as viewed vertically from above. The unit regions have equal sizes. Specifically, in the case in which an x-axis and a z-axis, which are horizontal and orthogonal to each other, and a y-axis, which is vertical, are set in the game field, the game field is divided by a plurality of planes parallel to the xy plane and a plurality of planes parallel to the yz plane into squares in a grid pattern, each of which is a unit region. Thus, in the game field, unit regions are arranged side by side in the horizontal direction (specifically, the front-back direction and the left-right direction) in the game space.

A shape of the game field is determined using terrain objects L (pieces) as units. Terrain objects L are elements constituting the game field. The shape of the game field can be changed by performing movement, addition, removal, or the like on a terrain object L by terrain object L basis. A size of a terrain object L in the horizontal direction of the game space is equal to that of a unit region, and a length of a terrain object L in the vertical direction of the game space is equal to a length of a unit region in the horizontal direction of the game space.

A terrain object L has a rectangular cuboid shape (more specifically, a cubic shape). A game field is constituted by terrain objects L arranged in a grid pattern in the game space. As an example, in the present example, in the game system 1, a parameter related to a terrain object L is set for a coordinate point set in the game space, and for each of a plurality of coordinate points, a parameter indicating whether or not a terrain object L exists at that coordinate point is stored. Thus, in the game system 1, a shape constituted by a plurality of terrain objects L in the game space can be specified by managing whether or not a terrain object L exists at each coordinate point in the game space (e.g., storing the parameter for each coordinate point). It should be noted that the surface of the terrain object L may have roughness, and may have a rounded corner.

In another example, in the game system 1, a parameter may be set for each terrain object L existing in the game space. The parameter set for each terrain object L indicates at least the location of the terrain object L in the game space. Thus, in the game system 1, by managing the location of each terrain object L in the game space (e.g., storing the parameter for each terrain object L), a shape constituted by a plurality of terrain objects L in the game space (the shape of a game field) can be specified. It should be noted that the parameter set for each terrain object L may include other parameters indicating a basic state of the terrain object L or other parameters that vary according to a user's operation.

In the present example, by a player character PC performing a predetermined action based on a user's operation, a terrain object can be generated, the generated terrain object can be edited, the generated terrain object can be duplicated, and the like. The terrain object generation includes causing a new terrain object to appear in the game space by moving and combining terrain objects L arranged in the game space or new terrain objects, and the like. The editing of a terrain object includes updating a terrain object by moving the terrain object, changing the appearance or properties of the terrain object, or newly joining the terrain object to another terrain object, and the like. In addition, the duplication of a terrain object includes causing a copy of the terrain object to appear in the game space, and the like.

In the present example, by rewriting and updating the parameter so as to remove a portion of a plurality of terrain objects L constituting a terrain to edit a state of the terrain objects L, the shape of the terrain can be easily changed. In addition, in the case in which a terrain is added, as in the case in which terrain objects L are removed, by rewriting and updating the parameter so as to arrange terrain objects L on a terrain object L by terrain object L basis to edit a state of the terrain objects L, the shape of the terrain can be easily changed. Thus, in the present example, by rewriting the parameter, terrain objects in the game space can be easily generated, edited, and the like.

In addition, in the present example, a terrain in the game space may be constituted by a plurality of types of terrain objects having different properties or appearances. In that case, the parameter may include any data that can specify the properties or appearance of an arranged terrain object L. For example, the parameter may include data that can specify properties including whether or not a terrain object is allowed to be edited by a user, a material such as sand, rock, soil, or ice, brittleness, joinability to other objects, or the like, or data that can specify appearance indicating texture or the like used for a terrain object, or the like, whereby the states of a plurality of types of terrain objects can be set. In that case, by a player character PC editing the properties or appearance of a terrain object, the parameter for the edited terrain object may be able to be updated.

A terrain object may be joined to another neighboring terrain object, so that an integrated terrain object is generated or edited. For example, by a player character PC performing a predetermined action, a plurality of terrain objects that are a target of the action may be joined together to be integrated. In that case, the parameter may include data that can be used to determine whether or not terrain objects are joined together to be integrated or the like, thereby making it possible to set whether or not a terrain object is joined to and integrated with another terrain object.

In addition, when a terrain object L is destroyed by a player character PC to be removed from the game space, an item corresponding to the terrain object L (e.g., a card item indicating a material for the terrain object L) may be able to be caused to appear in the game space. In the present example, the changing of a state of the game space and the editing of a terrain object may include removing the terrain object L from the game space to cause the item to appear.

In addition, other states of a terrain object may be able to be edited. For example, the editing of a terrain object may include changing a shape or type of the terrain object itself arranged in the game space, changing or rotating the orientation of the terrain object arranged in the game space, changing the durability or properties (movability, joinability, or the like) of the terrain object arranged in the game space, and the like. In the present example, the parameter may be used to identify these states, and the parameter corresponding to a terrain object may be updated by rewriting the parameter.

In the present example, a terrain object L to be subjected to a predetermined process can also be set according to the player character PC's selection action. Here, in the present example, “setting an object as one to be subjected to a predetermined process” means that the object is changed from a unselected state in which the object is not selected as one to be subjected to the predetermined process to a selected state in which the object is selected as one to be subjected to the predetermined process. For example, in the game space, a terrain object L surrounded by a selection tool object OBJ generated by the player character PC is set as an object to be subjected to the predetermined process. Based on the user's operation, the player character PC moves in a three-dimensional game space constituted by a plurality of terrain objects L, and generates a selection tool object OBJ whose shape is changed based on the movement of the player character PC in the game space. If at least one of the terrain objects L is surrounded by the selection tool object OBJ in the game space, the surrounded terrain object(s) L is set as an object to be subjected to the predetermined process. As an example, the predetermined process is a process of associating a terrain object L set as an object to be subjected to the predetermined process with the player character PC, and moving the terrain object L in the game space according to the further movement of the player character PC.

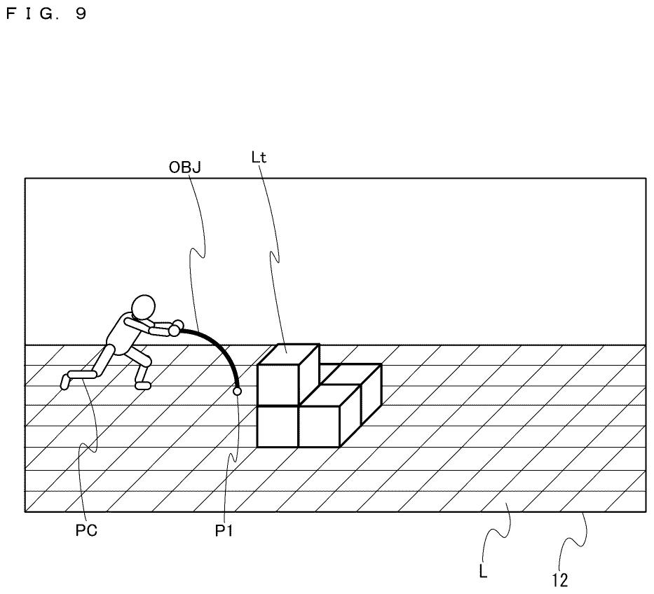

An example of the player character PC's action of surrounding terrain objects Lt using the selection tool object OBJ will be described with reference to FIGS. 9 to 12. As illustrated in FIG. 9, the player character PC performs an action of throwing a tip of the selection tool object OBJ according to the user's predetermined operation (e.g., an operation of pressing down an operation button 61 (ZR-button)). The selection tool object OBJ is a string-like object that is stretchable and whose shape is changed such that the object extends from the player character PC. When the tip of the selection tool object OBJ is brought into contact with another object or a field, the tip is fixed to a position based on the contact position. For example, in the example of FIG. 9, when the selection tool object OBJ is thrown onto a terrain object L included in a game field, so that the tip of the selection tool object OBJ is brought into contact with the terrain object L, a first reference point P1 is set at the contact position, and the tip is fixed to the first reference point P1. The selection tool object OBJ is generated and shaped to extend, connecting the first reference point P1 and the player character PC.

A position to which the tip of the selection tool object OBJ is thrown by the player character PC may be a predetermined position with reference to the position and orientation of the player character PC, or a position based on the user's operation. In the former case, the position to which the tip of the selection tool object OBJ is thrown may be a position that is a predetermined distance away from the player character PC in a direction in which the player character PC faces, or is directly below the player character PC. In the latter case, the tip of the selection tool object OBJ may be thrown toward a position in the game space that is overlaid by an aiming point displayed on the display 12 by moving the aiming point according to the user's predetermined operation (e.g., an operation of tilting the analog stick 32 or the analog stick 35 while pressing down the operation button 39 (ZL-button)).

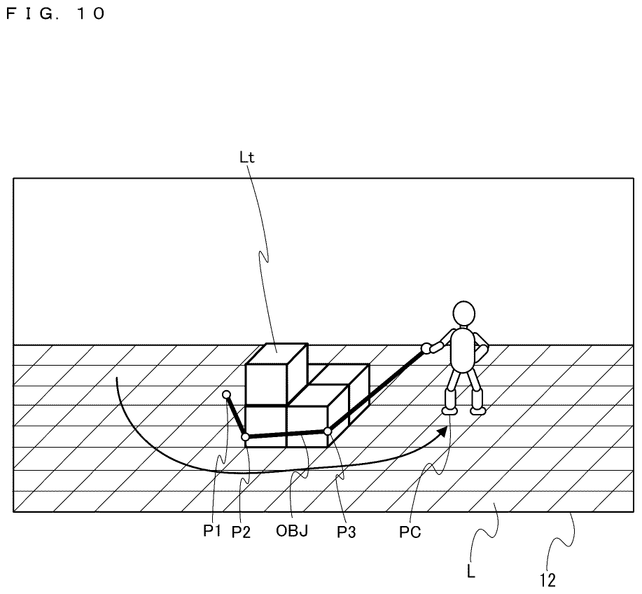

As illustrated in FIG. 10, after a first reference point P1 is set, during the time when the user's predetermined operation is continued (e.g., during the time when an operation of long-pressing the operation button 61 (ZR-button) is being performed, or during the time until the operation button 61 is pressed down again after having once been pressed down), the shape of the selection tool object OBJ is changed based on the movement of the player character PC with the tip fixed to the first reference point P1. For example, based on a destination position to which the player character PC has moved, the selection tool object OBJ turns, stretches or contracts, or deforms around the first reference point P1 to change the shape thereof so as to connect the first reference point P1 and the destination position with a straight line. When the selection tool object OBJ, the shape of which has been changed, is brought into contact with a terrain object Lt, a second reference point P2 is set as a new reference point with reference to the contact position.

After the second reference point P2 is set, during the time when the user's predetermined operation is continued, the shape of the selection tool object OBJ is further changed based on the movement of the player character PC with the tip of the selection tool object OBJ fixed to the first reference point P1 and a middle portion of the selection tool object OBJ fixed to the second reference point P2. For example, based on a destination position to which the player character PC has moved, the selection tool object OBJ further turns, stretches or contracts, or deforms around the second reference point P2 to change the shape thereof so as to connect the second reference point P2 and the destination position with a straight line. When the selection tool object OBJ, the shape of which has been changed, is brought into contact with a terrain object Lt again, a third reference point P3 is set as a new reference point with reference to the re-contact position. After the third reference point P3 is set, during the time when the user's predetermined operation is continued, the shape of the selection tool object OBJ is further changed based on the movement of the player character PC with the tip of the selection tool object OBJ fixed to the first reference point P1 and middle portions of the selection tool object OBJ fixed to the second reference point P2 and the third reference point P3.

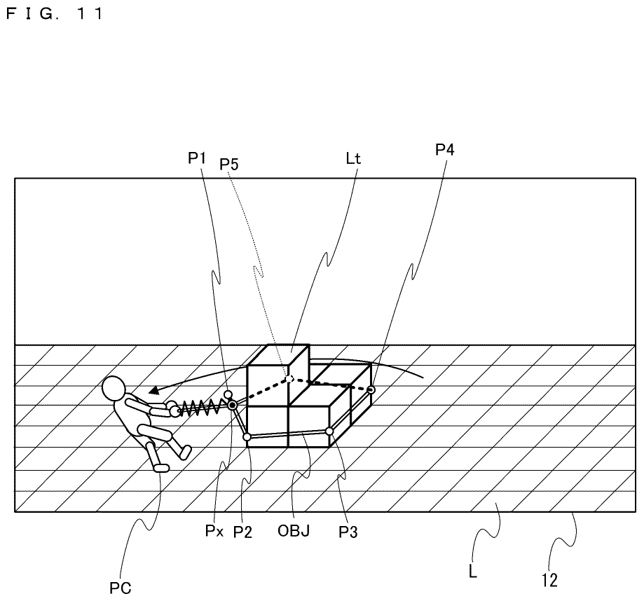

As illustrated in FIG. 11, when the player character PC moves around the terrain objects Lt while the user's predetermined operation is continued, a process of setting a new reference point based on contact between a terrain object Lt and the selection tool object OBJ is repeatedly executed, so that the terrain objects Lt are surrounded by the selection tool object OBJ. Thus, reference points are newly set based on contact between terrain objects Lt and the selection tool object OBJ, so that the terrain objects Lt can be surrounded by the selection tool object OBJ, which has a simple shape and a short length. In the game space, an intersection reference point Px is set at a position where the selection tool object OBJ, surrounding the terrain objects Lt, intersects itself (more specifically, a position where the selection tool object OBJ overlays itself as viewed in a predetermined direction (e.g., the vertical direction) of the game space). It should be noted that when three-dimensional terrain objects Lt arranged in a three-dimensional game space are surrounded by the string-like selection tool object OBJ, the selection tool object OBJ may twist and may not intersect itself. In the present example, the intersection reference point Px is set at a position where the selection tool object OBJ overlays itself as viewed in a predetermined direction (e.g., the vertical direction) of the game space. Therefore, even when the selection tool object OBJ twists and does not intersect itself, the intersection reference point Px can be set.

At this time, the selection tool object OBJ forms a loop surrounding the terrain objects Lt. When the loop is formed, the display form of the loop section of the selection tool object OBJ may be changed. As an example, the loop section of the selection tool object OBJ may be changed to be thicker or have a different color.

After the intersection reference point Px is set, the shape of the selection tool object OBJ is further changed so as to connect the intersection reference point Px and the destination position with a straight line with the loop maintained, based on the movement of the player character PC in a direction away from the intersection reference point Px while the user's predetermined operation is continued. At this time, the display form of the section of the selection tool object OBJ between the intersection reference point Px and the player character PC may be changed based on a change in the distance between the intersection reference point Px and the player character PC. As an example, the display form of the above section may be changed such that a spring stretches or contracts according to the above distance. When the distance between the intersection reference point Px and the player character PC is at least a predetermined distance, the predetermined process is executed on the terrain objects Lt surrounded by the selection tool object OBJ as an object to be processed. Thus, when the distance between the intersection reference point Px and the player character PC is at least a predetermined distance, the predetermined process is executed. However, the distance between the intersection reference point Px and the player character PC may not be permitted to become at least a predetermined distance due to a limitation on the environment of the game space. Therefore, it is possible to cause the user to decide how to surround an object using the selection tool object OBJ.

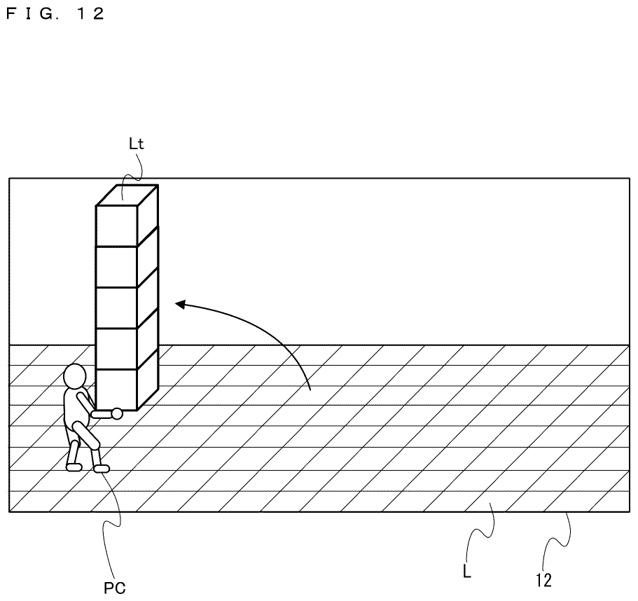

As illustrated in FIG. 12, by the predetermined process, the terrain objects Lt surrounded by the selection tool object OBJ are associated with the player character PC, and are moved in the game space according to the movement of the player character PC. As an example, by the predetermined process, the terrain objects Lt surrounded by the selection tool object OBJ are moved in the game space so as to be arranged and piled up at a position near the player character PC (e.g., near the hands or feet of the player character PC) in order of distance from the player character PC with the nearest first. Thereafter, the pile of the terrain objects Lt may be able to be further lifted and transported, placed on a game field, thrown forward, or the like by the player character PC's action. As another example, the terrain objects Lt surrounded by the selection tool object OBJ may be moved in the game space, following the movement of the player character PC, in order of distance from the player character PC with the nearest first. It should be noted that the above distance from the player character PC may be a shortest distance between a reference coordinate point set for the player character PC (e.g., the position of a foot of the player character PC or the center-of-gravity position of the body of the player character PC) and a reference coordinate point set for the terrain objects Lt (e.g., a central position of the terrain objects Lt) in the three-dimensional game space, or a straight-line distance between these reference coordinate points in a plane as viewed from directly above in the game space.

In another example, by the predetermined process, the terrain objects Lt surrounded by the selection tool object OBJ may be subjected to another type of editing. For example, by the predetermined process, predetermined damage may be given to a terrain object Lt set as an object to be subjected to the predetermined process, a terrain object Lt may be broken and removed from the game space, the properties, type, state, or the like of a terrain object Lt may be changed, the display form, size, shape, or the like of a terrain object Lt may be changed, or a plurality of terrain objects Lt may be combined into a single terrain object Lt.

It should be noted that a limit may be imposed on the number of terrain objects Lt to be subjected to the predetermined process. For example, the number of terrain objects Lt to be subjected to the predetermined process may be limited to at most a predetermined value (e.g., 10). As an example, a predetermined number of terrain objects Lt may be extracted in order of distance from the player character PC with the nearest first as those that are to be associated with the player character PC and moved in the game space according to the movement of the player character PC. In that case, terrain objects Lt that have not been extracted may not be moved in the predetermined process and the arrangement of these terrain objects Lt may be maintained, even when these terrain objects Lt are surrounded by the selection tool object OBJ.

In addition, a limit may be imposed on the size of terrain objects Lt that are to be subjected to the predetermined process. In the present example, a terrain object Lt that is obtained by combining a plurality of terrain objects and thus has a relatively large size may be set as an object to be subjected to the predetermined process when the terrain object Lt is surrounded by the selection tool object OBJ. Meanwhile, a size for which the predetermined process is to be executed may be limited to at most a predetermined size (e.g., a size corresponding to an object constituted by 10 unit objects).

In the case in which another terrain object Lis arranged directly above or below the terrain objects Lt that are to be subjected to the predetermined process, that terrain object L may or may not be set as an object to be subjected to the predetermined process. As a first example, terrain objects L that are located directly above and in a predetermined height range from the terrain objects Lt overlaid by the selection tool object as viewed in the horizontal direction are set as an object to be subjected to the predetermined process, and no terrain objects L that are located directly below the surrounded terrain objects Lt are set as an object to be subjected to the predetermined process. As a second example, terrain objects L that are located directly above and below and in a predetermined height range from the terrain objects Lt overlaid by the selection tool object as viewed in the horizontal direction are set as an object to be subjected to the predetermined process. As a third example, no terrain objects L that are located directly above and below and in a predetermined height range from the terrain objects Lt overlaid by the selection tool object as viewed in the horizontal direction are set as an object to be subjected to the predetermined process. As a fourth example, terrain objects L that are located directly below and in a predetermined height range from the terrain objects Lt overlaid by the selection tool object as viewed in the horizontal direction are set as an object to be subjected to the predetermined process, and no terrain objects L that are located directly above the surrounded terrain objects Lt are set as an object to be subjected to the predetermined process. It should be noted that in the first, second, and fourth examples, when terrain objects L are located directly above and below and beyond the predetermined height range from the terrain objects Lt overlaid by the selection tool object as viewed in the horizontal direction, none of all terrain objects L located directly above and below the selection tool object OBJ and the terrain objects Lt overlaid by the selection tool object OBJ as viewed in the horizontal direction may be set as an object to be subjected to the predetermined process. Alternatively, even when terrain objects L are located directly above or below and in the predetermined height range from the terrain objects Lt that are to be subjected to the predetermined process, then if the terrain objects L are not continuous to the terrain objects Lt that are to be subjected to the predetermined process, the terrain objects L may not be set as an object to be subjected to the predetermined process. In all of the above examples, terrain objects that are to be processed can be easily set, and therefore, an object of the examples may be selected, taking characteristics of a game or the like into account.

In addition, the selection tool object OBJ, when surrounding terrain objects Lt, may be able to form a plurality of loops. For example, after a loop is formed by the selection tool object OBJ surrounding terrain objects Lt, a new reference point may be able to be set by the selection tool object OBJ being brought into contact with another terrain object Lt before the distance between an intersection reference point belonging to the loop and the player character PC has reached at least the predetermined distance. As a result, a new loop that surrounds other terrain objects Lt can be formed based on the new reference point. Therefore, by the player character PC repeatedly performing such an action, the selection tool object OBJ can form a plurality of loops. In this case, all terrain objects Lt surrounded by the plurality of loops formed by the selection tool object OBJ may be set as an object to be subjected to the predetermined process.

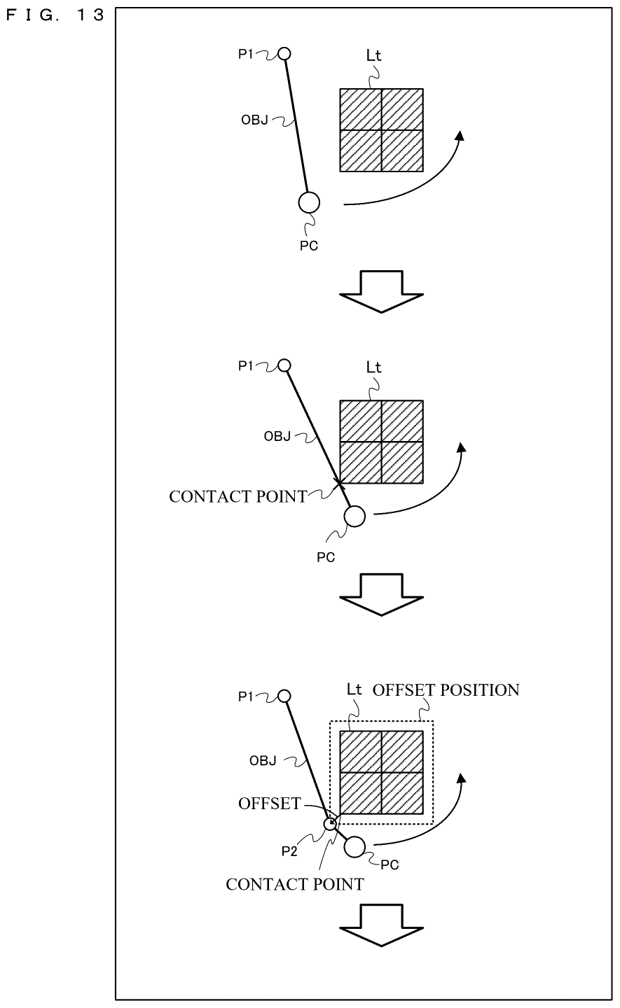

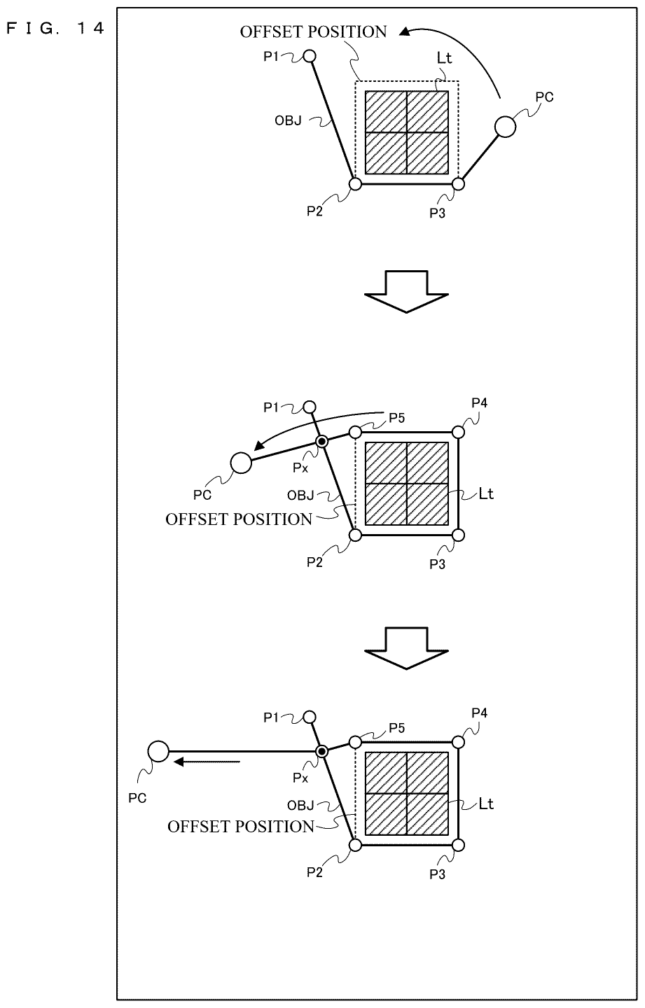

A more detailed example of changes in the shape of the selection tool object OBJ when the selection tool object OBJ surrounds terrain objects Lt will be described with reference to FIGS. 13 to 16. FIGS. 13 and 14 illustrate changes in the shape of the selection tool object OBJ from when the first reference point P1 is set to when the intersection reference point Px is set and the player character PC pulls the selection tool object OBJ, as viewed from above in the game space.

In the top diagram of FIG. 13, after a first reference point P1 is set near terrain objects Lt, the player character PC moves anticlockwise around the terrain objects Lt while generating the selection tool object OBJ. At this time, the selection tool object OBJ has a shape in which the first reference point P1 and the player character PC are connected with a straight line, and the shape of the selection tool object OBJ is changed by being turned/stretched or contracted around the first reference point P1 such that the other end of the selection tool object OBJ is moved according to the movement of the player character PC.

In the middle diagram of FIG. 13, due to the movement of the player character PC, the selection tool object OBJ, connecting the first reference point P1 and the player character PC, is brought into contact with the lower left corner of a terrain object Lt. A contact point is set at the corner of the terrain object Lt that the selection tool object OBJ is in contact with.

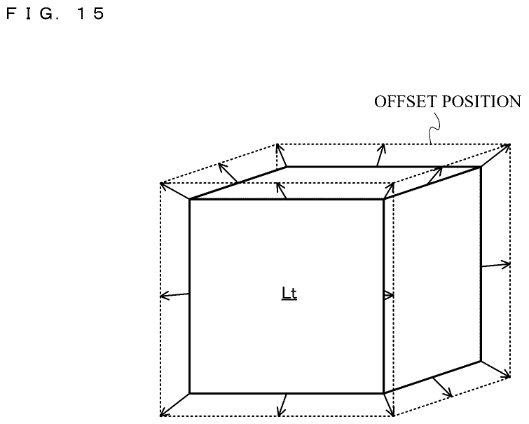

In the bottom diagram of FIG. 13, in the present example, when the contact point is thus set by the selection tool object OBJ being brought into contact with a terrain object Lt, a new reference point is set at a position (offset position) away from the terrain object Lt. For example, as illustrated in FIG. 15, offset positions are set for each terrain object Lt. Here, offset positions are set at positions that are a predetermined distance away from external surfaces of the terrain objects Lt in the normal directions. When a contact point is set on the external surface of a terrain object Lt, a new reference point is set at an offset position that is a predetermined distance away from the contact point in the normal direction. In the bottom diagram of FIG. 13, a second reference point P2 is set as a new reference point at an offset position that is a predetermined distance away from the contact point set at the corner of the terrain object Lt in the normal direction. It should be noted that an apparent contact point that is displayed when the selection tool object OBJ is brought into contact with a terrain object Lt may or may not be a reference point set at the offset position (e.g., a contact point may be displayed at a position where the selection tool object OBJ is actually in contact with a terrain object Lt). In the latter case, a calculated reference point for use in the process, and an apparent contact point displayed at a position where the selection tool object OBJ is in contact with a terrain object Lt, may be set at different positions.

Although the selection tool object OBJ is typically brought into contact with a corner (end portion) of a terrain object Lt, the selection tool object OBJ may be brought into contact with positions other than the corners (end portions) of a terrain object Lt. For example, when the player character PC throws the selection tool object OBJ for the first time, then if the selection tool object OBJ is brought into contact with the external surface of a terrain object Lt, a contact point may be set as a position other than the corners (end portions) of the terrain object Lt. In that case, even when a contact point is set at a position other than the corners (end portions) of the terrain object Lt, a reference point (e.g., the first reference point P1) is set at an offset position that is a predetermined distance away from the contact point in the normal direction.

In the bottom diagram of FIG. 13, after the second reference point P2 is set at the offset position of a terrain object Lt, the player character PC further moves anticlockwise around the terrain objects Lt. At this time, the selection tool object OBJ has a shape in which the first reference point P1 and the second reference point P2 are connected with a straight line, and the second reference point P2 and the player character PC are connected with a straight line, and the shape of the selection tool object OBJ is changed by the section of the selection tool object OBJ closer to the player character PC being turned/stretched or contracted around the second reference point P2 such that the other end of the selection tool object OBJ is moved according to the movement of the player character PC.

In the top diagram of FIG. 14, due to the movement of the player character PC, the section of the selection tool object OBJ connecting the second reference point P2 and the player character PC is brought into contact with the lower right corner of a terrain object Lt, and a contact point is set at the corner. A third reference point P3 is then set as a new reference point at an offset position that is a predetermined distance away from the contact point in the normal direction. At this time, the selection tool object OBJ has a shape in which the first reference point P1 and the second reference point P2 are connected with a straight line, the second reference point P2 and the third reference point P3 are connected with a straight line, and the third reference point P3 and the player character PC are connected with a straight line. Thereafter, when the player character PC further moves anticlockwise around the terrain objects Lt, the shape of the selection tool object OBJ is changed by the section of the selection tool object OBJ closest to the player character PC being turned/stretched or contracted around the third reference point P3 such that the other end of the selection tool object OBJ is moved according to the movement of the player character PC.

In the middle diagram of FIG. 14, as with the second reference point P2 and the third reference point P3, a fourth reference point P4 and a fifth reference point P5 are set near the upper right corner of a terrain object Lt and the upper left corner of a terrain object Lt. Thereafter, when the player character PC moves across the section of the selection tool object OBJ between the first reference point P1 and the second reference point P2, an intersection reference point Px is set at a position where the selection tool object OBJ intersects itself as viewed in the vertical direction of the game space. As a result, the selection tool object OBJ forms a loop surrounding the terrain objects Lt, passing through the intersection reference point Px and the second to fifth reference points P2 to P5, and the terrain objects Lt surrounded by the loop-shaped selection tool object OBJ are set as an object to be subjected to the predetermined process.

In the bottom diagram of FIG. 14, after the intersection reference point Px is set, the player character PC moves in a direction away from the intersection reference point Px. At this time, the shape of the selection tool object OBJ is changed such that the intersection reference point Px and the player character PC are connected with a straight line while keeping the loop surrounding the terrain objects Lt, and is changed by the section of the selection tool object OBJ closet to the player character PC being turned/stretched or contracted such that the other end of the selection tool object OBJ is moved according to the movement of the player character PC. Thereafter, when the distance between the intersection reference point Px and the player character PC is at least a predetermined distance, the predetermined process is executed on the terrain objects Lt surrounded by the selection tool object OBJ as an object to be processed.

In the present example, each reference point P is set at an offset position that is away from a terrain object Lt that the selection tool object OBJ is in contact with. As a result, when the selection tool object OBJ surrounds terrain objects Lt, the number of times the selection tool object OBJ is brought into contact with the terrain objects Lt can be reduced, resulting in a reduction in processing load for setting reference points P. For example, as illustrated in the top diagram of FIG. 14, during the time from when the second reference point P2 is set to when a contact point for setting the third reference point P3 occurs, the selection tool object OBJ is maintained away from the terrain objects Lt, and therefore, the selection tool object OBJ can be inhibited from being brought into contact with the external surfaces other than the corners (end portions) of the terrain objects Lt many times. This also holds true of other types of external surfaces of a terrain object Lt. A similar effect can be expected for a terrain object Lt having a polyhedral shape.

It should be noted that in another example, a contact position where the selection tool object OBJ is in contact with a terrain object Lt may be set as a reference point.

In addition, in the present example, the set reference point may be able to be removed. As a first example, the user's operation of causing the selection tool object OBJ to appear (e.g., an operation of long-pressing the operation button 61 (ZR-button)) is ended to remove all set reference points and then end the state in which the selection tool object OBJ is used. For example, when the user's operation described above is ended, the player character PC retracts the selection tool object OBJ, or the selection tool object OBJ is deleted from the game space, so that the state in which the selection tool object OBJ is used is ended.

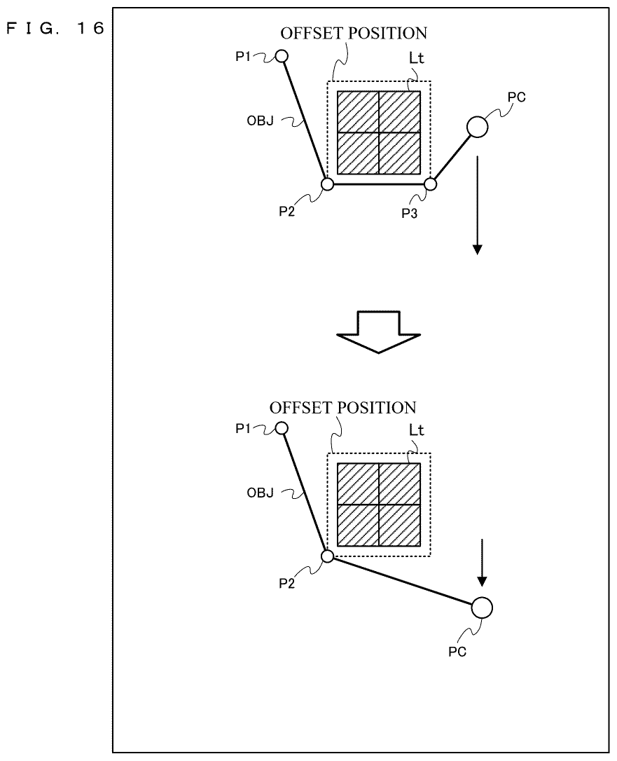

As a second example, as illustrated in FIG. 16, a reference point that has been most recently set may be removed according to the movement of the player character PC. As an example, in the top diagram of FIG. 16, as in the top diagram of FIG. 14, the selection tool object OBJ has a shape in which the first reference point P1 and the second reference point P2 are connected with a straight line, the second reference point P2 and the third reference point P3 are connected with a straight line, and the third reference point P3 and the player character PC are connected with a straight line. In this state, when the player character PC moves backward, e.g., clockwise, around terrain objects Lt surrounded by the selection tool object OBJ, a state occurs in which no obstacle such as a terrain object Lt is interposed between the reference point (e.g., the second reference point P2) immediately previous to the most recent reference point and the player character PC. When such a state occurs in which no obstacle such as a terrain object Lt is interposed between the reference point (e.g., the second reference point P2) immediately previous to the most recent reference point and the player character PC, the most recent reference point (e.g., the third reference point P3) may be removed, considering that a condition under which the most recent reference point is removed is satisfied. It should be noted that the above obstacle may be a virtual object such as a terrain object Lt that has a real body, or an offset range that is set for the virtual object. In the former case, in the example of FIG. 16, when no terrain object Lt is interposed between the second reference point P2 and the player character PC, the condition under which the most recent reference point is removed is satisfied. In the latter case, in the example of FIG. 16, when a state occurs in which no offset range of a terrain object Lt is interposed between the second reference point P2 and the player character PC, the condition under which the most recent reference point is removed is satisfied.

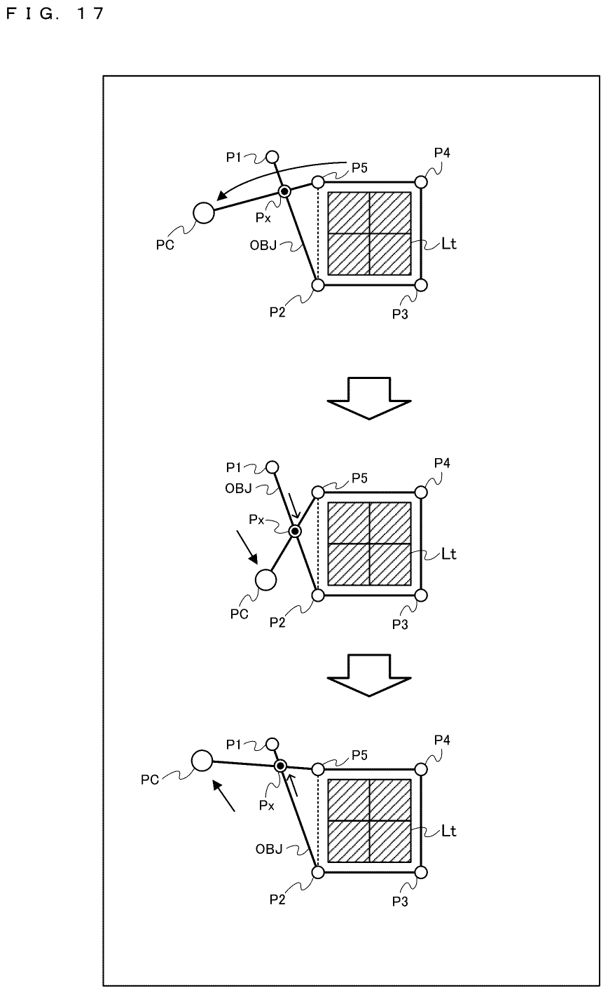

It should be noted that in another example, after the intersection reference point Px has once been set, the position of the intersection reference point Px may be changed. In the above example, as can be seen from the middle and bottom diagrams of FIG. 14, after the intersection reference point Px has once been set, the position of the intersection reference point Px is fixed in the game space, and is not changed due to the movement of the player character PC after the setting. In contrast to this, as illustrated in FIG. 17, in another example, even after the intersection reference point Px has once been set, the position of the intersection reference point Px is moved according to the movement of the player character PC. As a result, the selection tool object OBJ forms a loop that passes through the movable intersection reference point Px and the second to fifth reference points P2 to P5 and surrounds terrain objects Lt. The terrain objects Lt surrounded by the loop-shaped selection tool object OBJ are set as an object to be subjected to the predetermined process. Even if the intersection reference point Px is thus moved, then when the distance between the movable intersection reference point Px and the player character PC is at least a predetermined distance, the predetermined process may be executed on the terrain objects Lt that have been set as an object to be subjected to the predetermined process.

In the top diagram of FIG. 17, as in the middle diagram of FIG. 14, when the player character PC moves across the section of the selection tool object OBJ between the first reference point P1 and the second reference point P2, an intersection reference point Px is set at a position where the selection tool object OBJ intersects itself as viewed in the vertical direction of the game space. Thereafter, in the present example, the shape of the selection tool object OBJ is changed by the section of the selection tool object OBJ closest to the player character PC being turned/stretched or contracted around the fifth reference point P5 such that the other end of the selection tool object OBJ is moved according to the movement of the player character PC, and therefore, the position where the selection tool object OBJ intersects itself is changed. Specifically, the position where the selection tool object OBJ intersects itself is a position where the straight line section connecting the first reference point P1 and the second reference point P2 intersects the straight line section connecting the fifth reference point P5 and the player character PC as viewed in the vertical direction of the game space, and is changed according to the movement of the player character PC.

For example, as illustrated in the middle diagram of FIG. 17, after the intersection reference point Px has once been set, when the player character PC further moves anticlockwise around the terrain objects Lt surrounded by the selection tool object OBJ, the section of the selection tool object OBJ connecting the fifth reference point P5 and the player character PC also turns anticlockwise around the fifth reference point P5. The position where the section of the selection tool object OBJ between the first reference point P1 and the second reference point P2 intersects the section of the selection tool object OBJ connecting the fifth reference point P5 and the player character PC then moves in a direction from the first reference point P1 toward the second reference point P2 as viewed in the vertical direction of the game space, and therefore, the intersection reference point Px, which is set at the intersection position, is also moved.

In addition, as illustrated in the bottom diagram of FIG. 17, after the intersection reference point Px has once been set, when the player character PC moves clockwise around the terrain objects Lt surrounded by the selection tool object OBJ, the section of the selection tool object OBJ connecting the fifth reference point P5 and the player character PC is also turned clockwise around the fifth reference point P5. The intersection position is then moved in a direction from the second reference point P2 toward the first reference point P1, and therefore, the intersection reference point Px, which is set at the intersection position, is also moved.

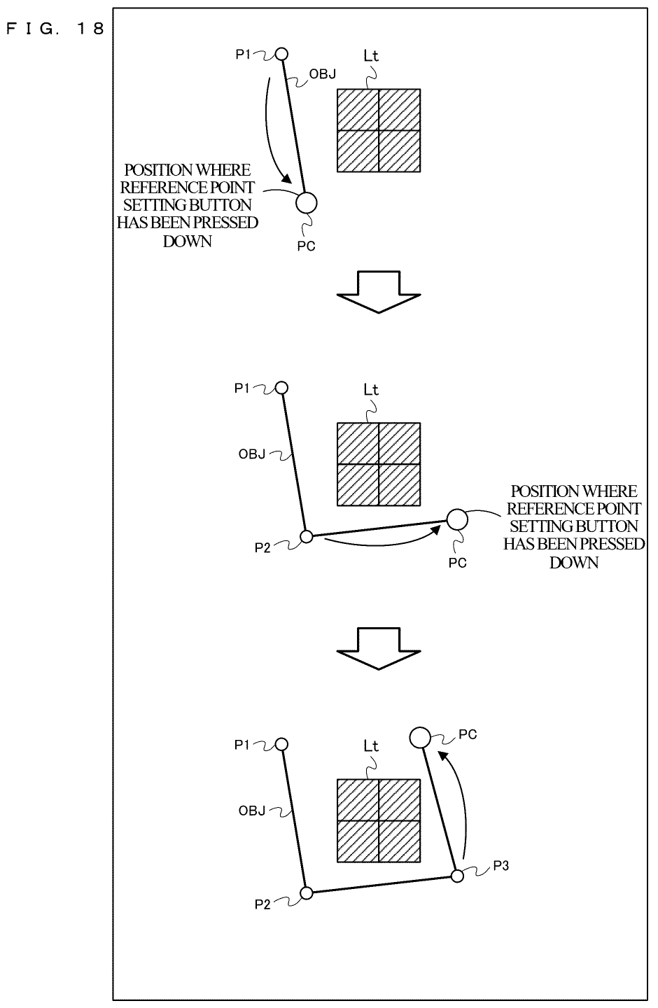

In another example, reference points for the selection tool object OBJ may be set based on the user's predetermined operation. For example, as illustrated in FIG. 18, while the user's operation of generating the selection tool object OBJ is continued (e.g., an operation of long-pressing the operation button 61 (ZR-button) is being performed), then if the user's another operation (an operation of pressing down a reference point setting button (e.g., the operation button 53 (A-button))) is performed during the movement of the player character PC, a new reference point may be set at the position of the player character PC.

For example, as illustrated in the top diagram of FIG. 18, after a first reference point P1 is set near terrain objects Lt, the player character PC moves anticlockwise around the terrain objects Lt while generating the selection tool object OBJ. At this time, the selection tool object OBJ has a shape in which the first reference point P1 and the player character PC are connected with a straight line, and the shape of the selection tool object OBJ is changed by being turned/stretched or contracted around the first reference point P1 such that the other end of the selection tool object OBJ is moved according to the movement of the player character PC. When the user's operation of pressing down the reference point setting button is performed, a second reference point P2 is set as a new reference point at a position immediately below the player character PC in the game space. As a result, the selection tool object OBJ, which has a shape in which the first reference point P1 and the second reference point P2 are connected with a straight line, is arranged in the game space.

As illustrated in the middle diagram of FIG. 18, after the second reference point P2 is set, the player character PC further moves anticlockwise around the terrain objects Lt. At this time, the selection tool object OBJ has a shape in which the first reference point P1 and the second reference point P2 are connected with a straight line, and the second reference point P2 and the player character PC are connected with a straight line, and the shape of the selection tool object OBJ is changed by the section of the selection tool object OBJ closer to the player character PC being turned/stretched or contracted around the second reference point P2 such that the other end of the selection tool object OBJ is moved according to the movement of the player character PC. When the user's operation of pressing down the reference point setting button is performed the second time, a third reference point P3 is set as a new reference point at a position immediately below the player character PC in the game space. As a result, the selection tool object OBJ, which has a shape in which the first reference point P1 and the second reference point P2 are connected with a straight line, and the second reference point P2 and the third reference point P3 are connected with a straight line, is arranged in the game space.

As illustrated in the bottom diagram of FIG. 18, after the third reference point P3 is set, the player character PC further moves anticlockwise around the terrain objects Lt. At this time, the selection tool object OBJ has a shape in which the first reference point P1 and the second reference point P2 are connected with a straight line, the second reference point P2 and the third reference point P3 are connected with a straight line, and the third reference point P3 and the player character PC are connected with a straight line, and the shape of the selection tool object OBJ is changed by the section of the selection tool object OBJ closest to the player character PC being turned/stretched or contracted around the third reference point P3 such that the other end of the selection tool object OBJ is moved according to the player character PC. Thus, in that example, each reference point may be set based on the user's operation of pressing down the reference point setting button without contact between the selection tool object OBJ and the terrain objects Lt. Even in the case in which each reference point may be set based on the user's operation of pressing down the reference point setting button, the intersection reference point Px is set at the position where the selection tool object OBJ intersects itself, surrounding terrain objects Lt, so that the selection tool object OBJ forms a loop surrounding the terrain objects Lt, passing through each reference point, the terrain objects Lt surrounded by the loop-shaped selection tool object OBJ are set as an object to be subjected to the predetermined process. It should be noted that in that example, reference points may also be set based on contact between the selection tool object OBJ and terrain objects Lt. Specifically, when the selection tool object OBJ is brought into contact with terrain objects Lt during the movement of the player character PC while reference points are set based on the user's operation of pressing down the reference point setting button, reference points may be set based on the above contact positions.

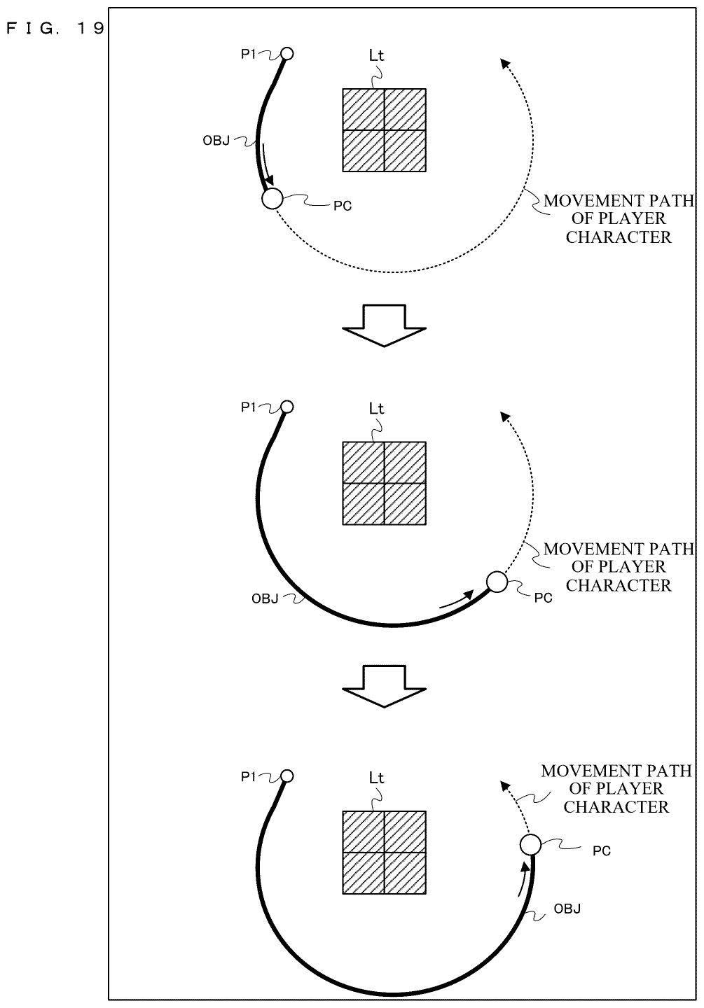

In another example, the shape of the selection tool object OBJ may be changed according to a movement path of the player character PC in the game space after a first reference point P1 is set. For example, as illustrated in the top, middle, and bottom diagrams of FIG. 19, after a first reference point P1 is set near terrain objects Lt, the player character PC moves anticlockwise around the terrain objects Lt while generating the selection tool object OBJ. At this time, the selection tool object OBJ is arranged in the game space in a shape following the movement path of the player character PC from the first reference point P1 to the current position of the player character PC after the first reference point P1 is set. Even in the case in which the selection tool object OBJ is generated along the movement path of the player character PC, when an intersection reference point Px is set at a position where the selection tool object OBJ intersects itself, surrounding the terrain objects Lt, so that the selection tool object OBJ forms a loop surrounding the terrain objects Lt, the terrain objects Lt surrounded by the loop-shaped selection tool object OBJ are set as an object to be subjected to the predetermined process.

In addition, in the present example, when the user's operation of causing the selection tool object OBJ to appear (e.g., an operation of long-pressing the operation button 61 (ZR-button)) is performed, the selection tool object OBJ appears in the game space, and the shape of the selection tool object OBJ is allowed to be changed by being stretched or contracted, deformed, or turned according to a subsequent action of the player character PC. In another example, when the user's operation of causing the selection tool object OBJ to appear is performed, the selection tool object OBJ may appear in the game space, and the shape of the selection tool object OBJ may be allowed to be changed by being further regenerated according to a subsequent action of the player character PC.

Although in the above example, the terrain objects Lt are illustrated as an object that is set as one to be subjected to the predetermined process when the object is surrounded by the selection tool object OBJ, other types of objects may be set as one to be subjected to the predetermined process. In another example, a specific object that is not set as one to be subjected to the predetermined process even when the object is surrounded by the selection tool object OBJ may be included in the game space. As an example, the specific object may be an object to which a load of at least a predetermined weight is applied from directly above, an object that is forbidden from being edited, an object that is arranged in an area in which editing is forbidden, an object that has at least a predetermined size, or the like. For example, when the specific object is included in objects surrounded by the selection tool object OBJ, the objects excluding the specific object may be set as one to be subjected to the predetermined process, or none of the objects surrounded by the selection tool object OBJ may be set as one to be subjected to the predetermined process.

Although in the above example, terrain objects Lt that the user desires to set as an object to be subjected to the predetermined process are surrounded by the selection tool object OBJ by the player character PC moving around the terrain objects Lt (in front of, behind, and on the left and right sides of the terrain objects Lt), the terrain objects Lt may be set as an object to be subjected to the predetermined process by the player character PC moving around the terrain objects Lt in other planes. For example, terrain objects Lt that the user desires to set as an object to be subjected to the predetermined process may be surrounded by the selection tool object OBJ by the player character PC moving around the terrain objects Lt (above, below, and on the left and right sides of the terrain objects Lt, or above, below, in front of, and behind the terrain objects Lt). The terrain objects Lt thus surrounded may be set as an object to be subjected to the predetermined process. In that case, the intersection reference point Px of the selection tool object OBJ may be set at a position where the selection tool object OBJ intersects itself as viewed in the depth direction or the left-right direction of the game space.

In addition, as described above, the selection tool object OBJ may form a plurality of loops. In an embodiment in which an object that is to be subjected to the predetermined process is set using the plurality of loops, terrain objects may be appropriately selected, taking characteristics of a game into account. For example, when a plurality of loops intersecting each other are formed, terrain objects Lt included in a range in which the loops are combined together may be set as an object to be subjected to the predetermined process.

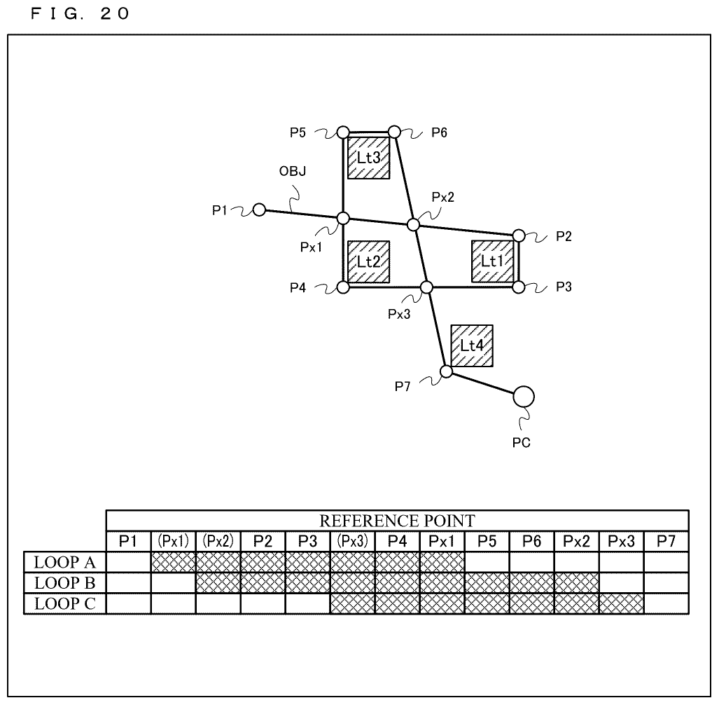

For example, as illustrated in FIG. 20, an example will be described in which the selection tool object OBJ forms a plurality of loops intersecting each other. In FIG. 20, after a first reference point P1 is set, the player character PC moves around terrain objects Lt1 to Lt4 while generating the selection tool object OBJ. Specifically, after the player character PC sets the first reference point P1, when the selection tool object OBJ is brought into contact with the terrain object Lt1, the player character PC sets a second reference point P2 and a third reference point P3. Then, when the selection tool object OBJ is brought into contact with the terrain object Lt2, the player character PC sets a fourth reference point P4. Then, when the selection tool object OBJ is brought into contact with the terrain object Lt3, the player character PC sets a fifth reference point P5 and a sixth reference point P6. Then, when the selection tool object OBJ is brought into contact with the terrain object Lt4, the player character PC sets a seventh reference point P7. At this time, after a first intersection reference point Px1 is set at an intersection of the section of the selection tool object OBJ between the first reference point P1 and the second reference point P2 and the section of the selection tool object OBJ between the fourth reference point P4 and the fifth reference point P5, a second intersection reference point Px2 is set at an intersection of the section of the selection tool object OBJ between the first reference point P1 and the second reference point P2 and the section of the selection tool object OBJ between the sixth reference point P6 and the seventh reference point P7. Thereafter, a third intersection reference point Px3 is set at an intersection of the section of the selection tool object OBJ between the third reference point P3 and the fourth reference point P4 and the section of the selection tool object OBJ between the sixth reference point P6 and the seventh reference point P7.

In the present example, the reference points thus set are managed together with the positions where the reference points have been set, in the chronological order in which the reference points have been set. Specifically, in the example of FIG. 20, pieces of information about the reference points are stored in the order of P1, P2, P2, P3, P4, Px1, P5, P6, Px2, Px3, and P7. In addition, in the present example, the loops formed by the selection tool object OBJ are managed together with the reference points included in the loops in the order in which the loops have been established. Specifically, in the present example, at the time when a loop A has been established by setting of the first intersection reference point Px1, the loop A is managed together with the reference points (P2, P3, P4, and Px1) included in the loop A. Thereafter, at the time when a loop B has been established by setting of the second intersection reference point Px2, the loop B is managed together with the reference points (P2, P3, P4, (Px1,) P5, P6, Px2) included in the loop B. Thereafter, at the time when a loop C has been established by setting of the third intersection reference point Px3, the loop C is managed together with the reference points (P4, (Px1), P5, P6, (Px2,) Px3) included in the loop C. It should be noted that an intersection reference point Px is set at a position where two sections of the selection tool object OBJ intersect, and therefore, two pieces of information indicating the respective intersection positions of the two sections may be managed. For example, the intersection reference point Px1 is set by the selection tool object OBJ passing through the section of the selection tool object OBJ between the reference points P1 and P2 after the reference point P4 is set, and as a result, is also set on the selection tool object OBJ between the reference points P1 and P2. Therefore, as indicated by parentheses in FIG. 20, the intersection reference point Px1 may also be recorded between the reference point P1 and the reference point P2. Similarly, as indicated by parentheses in FIG. 20, the intersection reference point Px2 may also be recorded immediately before the reference point P2, and the intersection reference point Px3 may also be recorded between the reference point P3 and the reference point P4.

When the plurality of loops A to C have thus been established, terrain objects Lt included in a range obtained by combination of the loops A to C are set as an object to be subjected to the predetermined process. In the example of FIG. 20, the loop formation A+B+C surrounded by the reference points P2, P3, Px3, P4, Px1, P5, P6, and Px2 is set as the combination range, and the terrain objects Lt1 to Lt3, which are included in the range, are set as an object to be subjected to the predetermined process.

Alternatively, an object that is to be subjected to the predetermined process may be set without being surrounded by the selection tool object OBJ. For example, when the selection tool object OBJ is thrown by the player character PC according to an operation of pressing down the operation button 61 (ZR-button), then if the tip of the selection tool object OBJ is brought into contact with an external surface of a terrain object Lt, a first reference point P1 is set at the contact position, and the tip is fixed. In that case, the terrain object Lt to which the tip of the selection tool object OBJ is fixed, can be set as an object to be subjected to the predetermined process although the terrain object Lt is not surrounded by the selection tool object OBJ. Specifically, when the distance between the first reference point P1 set on the external surface of the terrain object Lt and the player character PC is at least a predetermined distance (more specifically, the player character PC is moved backward in a direction away from the external surface of the terrain object Lt on which the first reference point P1 is set, by at least a predetermined distance), the predetermined process is executed on the terrain object Lt alone as an object to be processed. It should be noted that the predetermined distance for execution of the predetermined process may be changed to increase as the distance between the position of the player character PC when the first reference point P1 is set and the first reference point P1 increases.

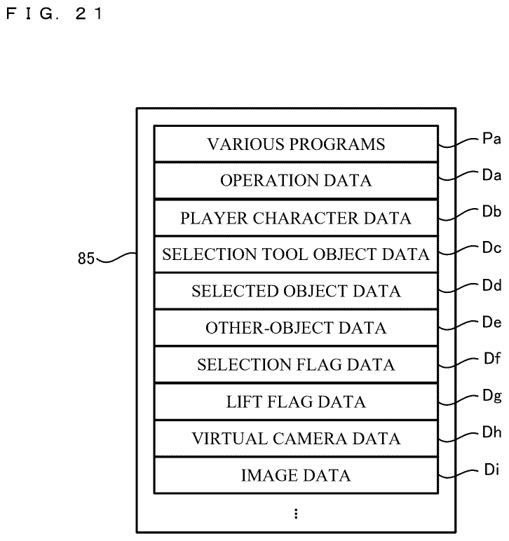

Next, an example of a specific process that is executed in the game system 1 will be described with reference to FIG. 21. It should be noted that in addition to data illustrated in FIG. 21, the DRAM 85 also stores data that is used in other processes, which will not be described in detail.

Various programs Pa that are executed in the game system 1 are stored in a program storage area of the DRAM 85. In the present example, the programs Pa include an application program (e.g., a game program) for performing information processing based on data obtained from the left controller 3 and/or the right controller 4 and the main body apparatus 2, and the like. Note that the programs Pa may be previously stored in the flash memory 84, may be obtained from a storage medium removably attached to the game system 1 (e.g., a predetermined type of storage medium attached to the slot 23) and then stored in the DRAM 85, or may be obtained from another apparatus via a network, such as the Internet, and then stored in the DRAM 85. The processor 81 executes the programs Pa stored in the DRAM 85.

In addition, the data storage area of the DRAM 85 stores various kinds of data that are used in processes that are executed in the game system 1 such as information processes. In the present example, the DRAM 85 stores operation data Da, player character data Db, selection tool object data Dc, selected object data Dd, other-object data De, selection flag data Df, lift flag data Dg, virtual camera data Dh, image data Di, and the like.

The operation data Da is obtained, as appropriate, from each of the left controller 3 and/or the right controller 4 and the main body apparatus 2. As described above, the operation data obtained from each of the left controller 3 and/or the right controller 4 and the main body apparatus 2 includes information about an input from each input section (specifically, each button, an analog stick, or a touch panel) (specifically, information about an operation). In the present example, operation data is obtained from each of the left controller 3 and/or the right controller 4 and the main body apparatus 2. The obtained operation data is used to update the operation data Da as appropriate. It should be noted that the operation data Da may be updated for each frame that is the cycle of a process executed in the game system 1, or may be updated each time operation data is obtained.

The player character data Db indicates parameters such as the position, direction, pose, action, state, ability, remaining energy, and the like in a game space of a player character PC operated by the user of the game system 1, and the like.

The selection tool object data Dc indicates parameters such as reference points, shape, position, display form, and the like of the selection tool object OBJ in the game space.

The selected object data Dd indicates an object (e.g., a terrain object(s)) that has been surrounded by the selection tool object OBJ to be set as a selected object.

The other-object data De indicates parameters such as the positions, directions, poses, actions, states, types, offset positions, and the like of other objects (e.g., terrain objects) in the game space.

The selection flag data Df indicates a selection flag. When the selection flag is set on, the selection tool object OBJ is allowed to be used. The lift flag data Dg indicates a lift flag. When the lift flag is set on, an object that is to be processed is allowed to be lifted and moved.

The virtual camera data Dh indicates the position, direction, angle of view, and the like of a virtual camera arranged in the game space.

The image data Di is for displaying images (e.g., an image of the player character PC, an image of the selection tool object OBJ, an image of each object, a map image, and a background image) on a display screen (e.g., the display 12 of the main body apparatus 2).

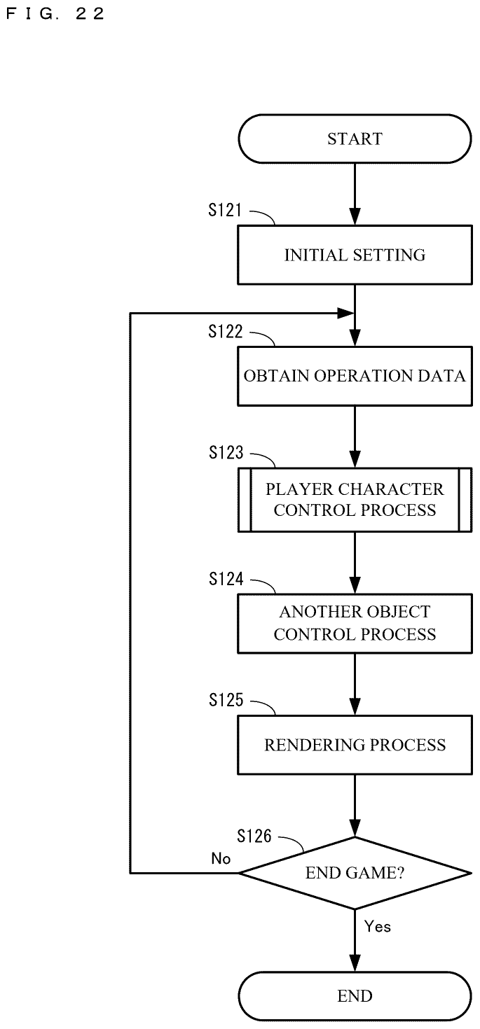

Next, a detailed example of a game process that is an example of an information process in the present example will be described with reference to FIGS. 22 to 25. In the present example, a series of steps illustrated in FIGS. 22 to 25 is executed by the processor 81 executing a predetermined application program (game program), a communication program, and the like included the programs Pa. The game process of FIGS. 22 to 25 is started with any appropriate timing.

It should be noted that the steps in the flowcharts of FIGS. 22 to 25, which are merely illustrative, may be executed in a different order, or another step may be executed in addition to (or instead of) each step, if a similar effect is obtained. In the present example, it is assumed that the processor 81 executes each step of the flowcharts. Alternatively, a portion of the steps of the flowcharts may be executed by a processor or dedicated circuit other than the processor 81. In addition, a portion of the steps executed by the main body apparatus 2 may be executed by another information processing apparatus that can communicate with the main body apparatus 2. Specifically, the steps of FIGS. 22 to 25 may be executed by a plurality of information processing apparatuses including the main body apparatus 2 cooperating with each other.

In FIG. 22, the processor 81 executes initial setting for the game process (step S121), and proceeds to the next step. For example, in the initial setting, the processor 81 initializes parameters for executing processes described below, and updates each data. As an example, the processor 81 arranges a player character PC, a virtual camera, and the like in a predetermined pose or orientation at a default position in the game space, and updates the player character data Db and the virtual camera data Dh. In addition, the processor 81 sets objects in the game space, and sets the other-object data De.

Next, the processor 81 obtains operation data from the left controller 3, the right controller 4, and/or the main body apparatus 2, updates the operation data Da (step S122), and proceeds to the next step.

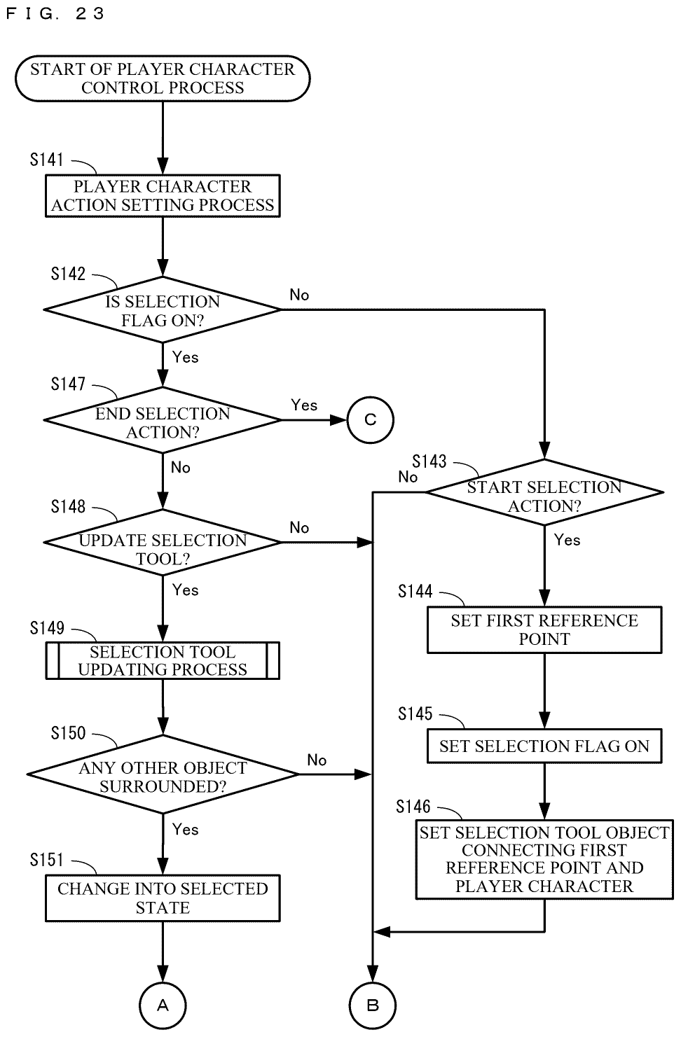

Next, the processor 81 executes a player character control process (step S123), and proceeds to the next step. The player character control process in step S123 will be described below with reference to FIG. 23.

In FIG. 23, the processor 81 executes a process of setting the player character PC's action (step S141), and proceeds to the next step. For example, the processor 81 sets the position, direction, pose, action, state, and the like of the player character PC based on an operation input indicated by the operation data Da, virtual physical calculation in the game space (e.g., virtual inertia and force of gravity), influence from other objects (e.g., attack by other characters), and the like, and updates the player character data Db.

Next, the processor 81 determines whether or not the selection flag is on (step S142). For example, if the selection flag indicated by the selection flag data Df is on, the result of the determination by the processor 81 in step S142 is positive. If the selection flag is off, the processor 81 proceeds to step S143. Otherwise, i.e., if the selection flag is on, the processor 81 proceeds to step S147.

In step S143, the processor 81 determines whether or not to start a selection action. As an example, if the operation data Da indicates that the user's operation for allowing the player character PC to perform an action of selecting an object using the selection tool object OBJ (e.g., an operation of long-pressing the operation button 61 (ZR-button)) has been started, the result of the determination by the processor 81 in step S143 is positive. If the processor 81 determines to start the selection action, the processer 81 proceeds to step S144. Otherwise, i.e., if the processor 81 determines not to perform the selection action, the processor 81 ends the subroutine.

In step S144, the processor 81 sets a first reference point, and proceeds to the next step. For example, the processor 81 references the player character data Db, and sets the first reference point at a predetermined position with reference to the position of the player character PC, and updates the selection tool object data Dc.

Next, the processor 81 sets the selection flag on, and updates the selection flag data Df (step S145), and proceeds to the next step.

Next, the processor 81 sets the selection tool object OBJ connecting the first reference point and the player character PC (step S146), and ends the subroutine. For example, the processor 81 changes the selection tool object OBJ into a shape connecting the player character PC and the first reference point set in step S144, with reference to the player character data Db and the selection tool object data Dc, and updates the selection tool object data Dc. It should be noted that in order to cause the selection tool object OBJ connecting the player character PC and the first reference point to appear, the player character PC is caused to start performing an action of throwing the tip of the selection tool object OBJ so that the tip reaches the first reference point in the game space, and after the start of the action, the player character PC and the selection tool object OBJ may be controlled by processes in step S141 described above and step S181 described below so that the action is performed over a predetermined period of time.

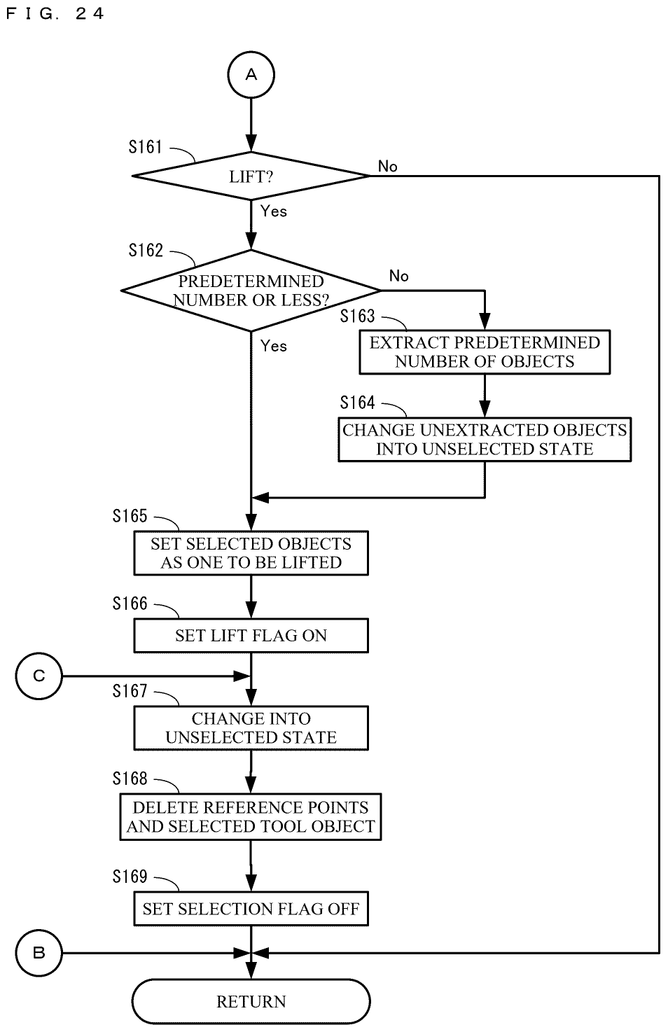

In step S147, the processor 81 determines whether or not to end the selection action. As an example, if the operation data Da indicates that the user's operation for causing the player character PC to perform an action of selecting an object using the selection tool object OBJ (e.g., an operation of long-pressing the operation button 61 (ZR-button)) has been ended, the result of the determination by the processor 81 in step S147 is positive. If the processor 81 determines not to end the selection action, the processor 81 proceeds to step S148. Otherwise, i.e., if the processor 81 determines to end the selection action, the processor 81 proceeds to step S167 (see FIG. 24).

In step S148, the processor 81 determines whether or not the selection tool object OBJ has been updated. For example, if a change has occurred in the shape or the like of the selection tool object OBJ due to the player character PC's action or the like, the result of the determination by the processor 81 in step S148 is positive. If the selection tool object OBJ has been updated, the processor 81 proceeds to step S149. Otherwise, i.e., if the selection tool object OBJ has not been updated, the processor 81 ends the subroutine.

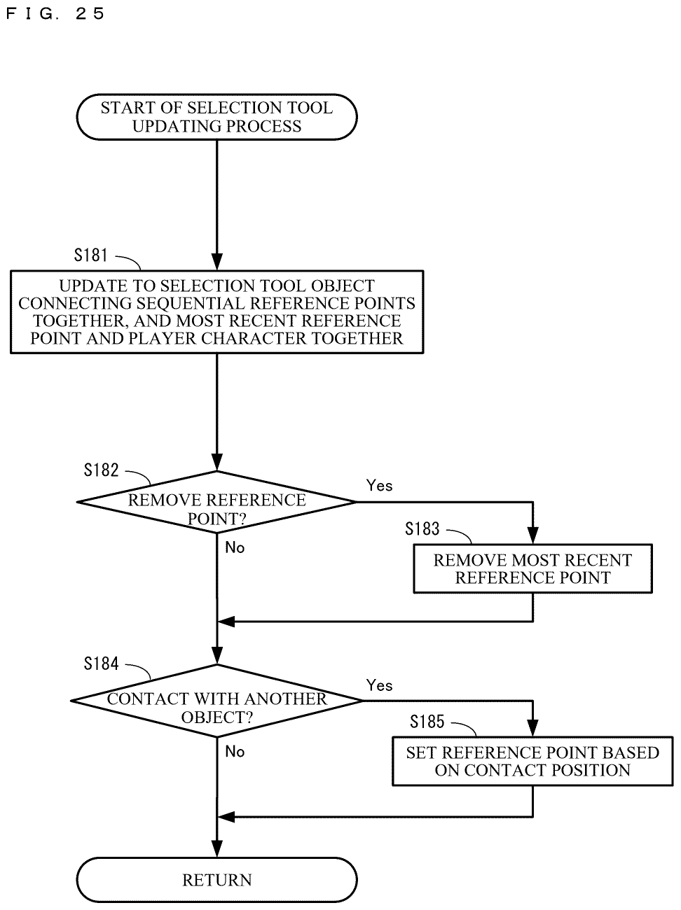

In step S149, the processor 81 executes a selection tool updating process, and proceeds to step S150. The selection tool updating process in step S149 will be described with reference to FIG. 25.

In FIG. 25, the processor 81 updates the selection tool object OBJ (step S181), and proceeds to the next step. For example, based on the player character data Db and the selection tool object data Dc, the processor 81 changes the selection tool object OBJ into a shape in which reference points that have been set sequentially in chronological order are connected with straight lines, and the reference point set most recently and the player character PC after the action are connected with a straight line, and updates the selection tool object data Dc.

Next, the processor 81 determines whether or not to remove a reference point (step S182). For example, if a condition under which a reference point set most recently is removed (e.g., no obstacle is present between a reference point immediately previous to the most recent one and the player character PC) is satisfied, the result of the determination by the processor 81 in step S182 is positive. If the processor 81 determines to remove a reference point, the processor proceeds to step S183. Otherwise, i.e., if the processor 81 determines not to remove a reference point, the processor proceeds to step S184.

In step S183, the processor 81 removes the reference point set most recently, and proceeds to step S184. For example, the processor 81 deletes data indicating the most recent one of the reference points indicated by the selection tool object data Dc.

In step S184, the processor 81 determines whether or not the selection tool object OBJ has been newly brought into contact with another object. If the selection tool object OBJ has been newly brought into contact with another object, the processor 81 proceeds to step S185. Otherwise, i.e., if the selection tool object OBJ has not been newly brought into contact with any other object, the processor 81 ends the subroutine.

In step S185, the processor 81 newly sets a reference point based on the new contact position, and ends the subroutine. For example, the processor 81 newly sets a reference point at an offset position that is a predetermined distance away from the new contact position to another object in the normal direction, and updates the selection tool object data Dc.

Referring back to FIG. 23, after the selection tool updating process in step S149, the processor 81 determines whether or not any other object is surrounded by the selection tool object OBJ (step S150). For example, if an intersection reference point has been set in the selection tool object data Dc, or if the selection tool object OBJ newly intersects itself, the result of the determination by the processor 81 in step S150 is positive. If another object is surrounded by the selection tool object OBJ, the processor 81 proceeds to step S151. Otherwise, i.e., if any other object is not surrounded by the selection tool object OBJ, the processor 81 ends the subroutine.

In step S151, the processor 81 changes the status of the selection tool object OBJ into one in which another object has been selected, and proceeds to step S161 (see FIG. 24). For example, if the selection tool object OBJ newly intersects itself, the processor 81 sets the position of the intersection as viewed in the vertical direction of the game space, as an intersection reference point, and updates the selection tool object data Dc. In addition, based on the selection tool object data Dc and the other-object data De, the processor 81 selects the object (e.g., a terrain object(s) Lt) surrounded by the selection tool object OBJ as a selected object, and updates the selected object data Dd with the selected object. In addition, the processor 81 changes the display forms of the section of the loop of the selection tool object OBJ surrounding the selected object and the section of the selection tool object OBJ between the intersection reference point Px and the player character PC from a normal display form, and updates the selection tool object data Dc.

Referring to FIG. 24, in step S161, the processor 81 determines whether or not to execute a lift action. For example, if, based on the player character data Db and the selection tool object data Dc, the processor 81 determines that the distance between the intersection reference point and the player character PC is at least a predetermined distance, the result of the determination by the processor 81 in step S161 is positive. If the processor 81 determines to execute the lift action, the processor 81 proceeds to step S162. Otherwise, i.e., the processor 81 determines not to execute the lift action, the processor 81 ends the subroutine.

In step S162, based on the selected object data Dd, the processor 81 determines whether or not the number of objects set as a selected object is at most a predetermined number. If the number of objects set as a selected object is not at most the predetermined number, the processor 81 proceeds to step S163. If the number of objects set as a selected object is at most the predetermined number, the processor 81 proceeds to step S165.

In step S163, the processor 81 extracts a predetermined number of objects from the selected objects, and proceeds to the next step. For example, based on the selected object data Dd, the processor 81 extracts a predetermined number of objects nearest to the player character PC from the objects set as a selected object.

Next, the processor 81 excludes objects that have not been extracted in step S163 from the objects set as a selected object, and updates the selected object data Dd (step S164), and proceeds to step S165.

In step S165, based on the selected object data Dd, the processor 81 sets the objects set as a selected object as an object that is to be subjected to the lift action, and proceeds to the next step.

Next, the processor 81 sets the lift flag on and updates the lift flag data Dg (step S166), and proceeds to the next step.

Next, the processor 81 deletes the selected objects indicated by the selected object data Dd, thereby changing the selected objects into an unselected state (step S167), and proceeds to the next step.

Next, the processor 81 deletes data related to the selection tool object OBJ that is indicated by the selection tool object data Dc (step S168), and proceeds to the next step.

Next, the processor 81 sets the selection flag off and updates the selection flag data Df (step S169), and ends the subroutine.

Referring back to FIG. 22, after the player character control process in step S123, the processor 81 executes another object control process (step S124), and proceeds to the next step. For example, the processor 81 moves the objects set as an object to be subjected to the lift action in step S165 in the game space such that the objects are piled up near the player character PC in order of distance from the player character PC with the nearest first, and updates the other-object data De based on the positions of the objects after the movement.

Next, the processor 81 executes a rendering process (step S125), and proceeds to the next step. In the present example, the processor 81 performs control to display, on the display 12, an image of the game space based on the results of the processes in steps S121 to S124. As an example, based on the other-object data De and the results of the above processes, the processor 81 sets a game space including objects such as terrain objects L. In addition, the processor 81 arranges and causes the player character PC, the selection tool object OBJ, and the like to perform an action in the game space based on the player character data Db and the selection tool object data Dc. In addition, the processor 81 sets the position and/or orientation of a virtual camera for generating a display image based on the virtual camera data Dh to arrange the virtual camera in the game space. Thereafter, the processor 81 generates an image of the game space as viewed from the virtual camera thus set, and controls the display 12 so that the game space image is displayed on the display 12. It should be noted that the processor 81 may execute a process of controlling the movement of the virtual camera in the game space based on the position and pose of the player character PC, and update the virtual camera data Dh. The processor 81 may also move the virtual camera based on the operation data Da, and update the virtual camera data Dh.

Next, the processor 81 determines whether or not to end the game process (step S126). In step S126, the game process is ended, for example, if a condition for ending the game process is satisfied, the user has performed an operation of ending the game process, or the like. If the processor 81 determines not to end the game process, the processor 81 returns to and repeats step S122. If the processor 81 determines to end the game process, the processor 81 ends the process of the flowchart. Following this, steps S122 to S126 are repeatedly executed until the processor 81 determines to end the game process in step S126.

Thus, in the present example, when a terrain object Lt is surrounded by the selection tool object OBJ in the game space, the terrain object Lt is set as an object to be subjected to a predetermined process. Therefore, an object to be processed can be easily set.

It should be noted that the game system 1 may be any suitable apparatus, including handheld game apparatuses, personal digital assistants (PDAs), mobile telephones, smartphones, personal computers, cameras, tablet computers, and the like.

In the foregoing, the information process (game process) is performed in the game system 1 by way of example. Alternatively, at least a portion of the process steps may be performed in another apparatus. For example, when the game system 1 can also communicate with another apparatus (e.g., a server, another information processing apparatus, another image display apparatus, another game apparatus, another mobile terminal, etc.), the process steps may be executed in cooperation with the second apparatus. By thus causing another apparatus to perform a portion of the process steps, a process similar to the above process can be performed. The above information process may be executed by a single processor or a plurality of cooperating processors included in an information processing system including at least one information processing apparatus. In the above example, the information processes can be performed by the processor 81 of the game system 1 executing predetermined programs. Alternatively, all or a portion of the above processes may be performed by a dedicated circuit included in the game system 1.

Here, according to the above variation, the present example can be implanted in a so-called cloud computing system form or distributed wide-area and local-area network system forms. For example, in a distributed local-area network system, the above process can be executed by cooperation between a stationary information processing apparatus (a stationary game apparatus) and a mobile information processing apparatus (handheld game apparatus). It should be noted that, in these system forms, each of the steps may be performed by substantially any of the apparatuses, and the present example may be implemented by assigning the steps to the apparatuses in substantially any manner.

The order of steps, setting values, conditions for determination, etc., used in the above information process are merely illustrative, and of course, other order of steps, setting values, conditions for determination, etc., may be used to implement the present example. In addition, the example operation button used in the above operation is merely illustrative, and the above examples may be implemented using other operation buttons.

The above programs may be supplied to the game system 1 not only through an external storage medium, such as an external memory, but also through a wired or wireless communication line. The program may be previously stored in a non-volatile storage device in the game system 1. Examples of an information storage medium storing the program include non-volatile memories, and in addition, CD-ROMs, DVDs, optical disc-like storage media similar thereto, and flexible disks, hard disks, magneto-optical disks, and magnetic tapes. The information storage medium storing the program may be a volatile memory storing the program. Such a storage medium may be said as a storage medium that can be read by a computer, etc. (computer-readable storage medium, etc.). For example, the above various functions can be provided by causing a computer, etc., to read and execute programs from these storage media.

While several example systems, methods, devices, and apparatuses have been described above in detail, the foregoing description is in all aspects illustrative and not restrictive. It should be understood that numerous other modifications and variations can be devised without departing from the spirit and scope of the appended claims. It is, therefore, intended that the scope of the present technology is limited only by the appended claims and equivalents thereof. It should be understood that those skilled in the art could carry out the literal and equivalent scope of the appended claims based on the description of the present example and common technical knowledge. It should be understood throughout the present specification that expression of a singular form includes the concept of its plurality unless otherwise mentioned. Specifically, articles or adjectives for a singular form (e.g., “a”, “an”, “the”, etc., in English) include the concept of their plurality unless otherwise mentioned. It should also be understood that the terms as used herein have definitions typically used in the art unless otherwise mentioned. Thus, unless otherwise defined, all scientific and technical terms have the same meanings as those generally used by those skilled in the art to which the present example pertain. If there is any inconsistency or conflict, the present specification (including the definitions) shall prevail.

As described above, the present example is usable as a game program, game system, game apparatus, game processing method, and the like in which an object to be processed or the like can be easily set.

What is claimed is:

1. One or more non-transitory computer-readable storage media having stored therein a program that when executed, causes one or more processors of an information processing apparatus to execute information processing comprising:
causing a player character to move in a three-dimensional virtual space according to a first operation input;
generating, in the three-dimensional virtual space, a first object that connects a reference point set at a position according to a second operation input, and the player character, wherein a shape of the first object is changed based on movement of the player character; and
when a second object is surrounded by the first object in the three-dimensional virtual space, designating the second object for further game processing.

2. The one or more non-transitory computer-readable storage media according to claim 1, wherein
the information processing further comprises:
based on a position of the player character, setting a new reference point at a position different from the reference point; and
changing the shape of the first object such that the plurality of reference points and the player character are connected with straight lines.

3. The one or more non-transitory computer-readable storage media according to claim 2, wherein
the information processing further comprises:
changing the shape of the first object such that the first object connects the reference point and a destination position to which the player character has moved, according to at least one of turning of the first object around the reference point and a change in a length of the first object to the reference point based on the destination position; and
setting a new reference point when the first object, the shape of which has been changed, is brought into contact with the second object.

4. The one or more non-transitory computer-readable storage media according to claim 3, wherein
the information processing further comprises:
setting the new reference point at a position away from the second object when the first object is brought into contact with the second object.

5. The one or more non-transitory computer-readable storage media according to claim 1, wherein the second object is subjected to the further game processing, based on further movement of the player character.

6. The one or more non-transitory computer-readable storage media according to claim 5, wherein
the further game processing comprises moving the designated second object in the three-dimensional virtual space, in association with the player character, according to further movement of the player character.

7. The one or more non-transitory computer-readable storage media according to claim 1, wherein
the information processing further comprises:
executing the further game processing when a distance between the player character and an intersection position where the first object intersects itself, surrounding the second object, as viewed in a first direction in the three-dimensional virtual space is at least a first distance.

8. The one or more non-transitory computer-readable storage media according to claim 7, wherein
the information processing further comprises:
when a section of the first object connecting the reference point and the player character is moved by movement of the player character, then if the intersection position where the first object intersects itself as viewed in the first direction is changed, executing the further game processing using the changed intersection position.

9. The one or more non-transitory computer-readable storage media according to claim 7, wherein
the information processing further comprises:
based on a change in a distance between the intersection position and the player character, changing a display form of at least a section of the first object connecting the intersection position and the player character.

10. The one or more non-transitory computer-readable storage media according to claim 1, wherein
the information processing further comprises:
when the second object is surrounded by the first object, changing a display form of the first object into a display form that is different from when the second object is not surrounded by the first object.

11. The one or more non-transitory computer-readable storage media according to claim 1, wherein
the information processing further comprises:
executing the further game processing on the designated second object when the reference point is set at a position based on the second object satisfying a condition according to the second operation input, and the player character moves in a direction away from the second object by at least a second distance.

12. The one or more non-transitory computer-readable storage media according to claim 1, wherein
the information processing further comprises:
setting a new reference point at a position different from the reference point based on a third operation input; and
changing the shape of the first object such that the plurality of reference points and the player character are connected with straight lines.

13. The one or more non-transitory computer-readable storage media according to claim 1, wherein
the information processing further comprises:
changing the shape of the first object according to a movement path of the player character after the reference point is set in the three-dimensional virtual space.

14. A game system comprising one or more processors that are configured to execute information processing comprising:
causing a player character to move in a three-dimensional virtual space according to a first operation input;
generating, in the three-dimensional virtual space, a first object that connects a reference point set at a position according to a second operation input, and the player character, wherein a shape of the first object is changed based on movement of the player character; and
when a second object is surrounded by the first object in the three-dimensional virtual space, designating the second object for further game processing.

15. A game apparatus comprising one or more processors that are configured to execute information processing comprising:
causing a player character to move in a three-dimensional virtual space according to a first operation input;
generating, in the three-dimensional virtual space, a first object that connects a reference point set at a position according to a second operation input, and the player character, wherein a shape of the first object is changed based on movement of the player character; and
when a second object is surrounded by the first object in the three-dimensional virtual space, designating the second object for further game processing.

16. A game processing method performed on an information processing system, the game processing method comprising:
causing a player character to move in a three-dimensional virtual space according to a first operation input;
generating, in the three-dimensional virtual space, a first object that connects a reference point set at a position according to a second operation input, and the player character, wherein a shape of the first object is changed based on movement of the player character; and
when a second object is surrounded by the first object in the three-dimensional virtual space, designating the second object for further game processing.
